(19) United States
(12) Patent Application Publication
(10) Pub. No.: US 2025/0045354 A1
(43) Pub. Date: Feb. 6, 2025

(54) FEATURE QUANTITY SELECTION DEVICE, FEATURE QUANTITY SELECTION METHOD, AND RECORDING MEDIUM

(71) Applicant: NEC Corporation, Minato-ku, Tokyo (JP)

(72) Inventors: Chenhui HUANG, Tokyo (JP); Fumiyuki Nihey, Tokyo (JP)

(73) Assignee: NEC Corporation, Minato-ku, Tokyo (JP)

(21) Appl. No.: 18/717,019

(22) PCT Filed: Jan. 20, 2022
(86) PCT No.: PCT/JP2022/001953

§ 371 Date: Jun. 6, 2024

(51) Int. Cl. G06F 17/18

(52) U.S. Cl. CPC G06F 17/18

(57) ABSTRACT

A feature quantity selection device that includes an acquisition unit that acquire data sets, a construction unit that constructs re-extracted data sets by changing a distribution of data included in the data set, an analysis unit that analyze the re-extracted data sets using a Lasso regression method, a statistics unit that aggregates values of elements included in the re-extracted data sets in accordance with an analysis result of the re-extracted data sets and setting a logical value to the elements included in the re-extracted data sets in accordance with an aggregation result of the values of the elements, a selection unit that select a combination of feature quantities in accordance with a value of the logical value set to the elements in accordance with a preset specifying rule, and an output unit that outputs selection information regarding the selected combination of the feature quantities.

### TECHNICAL FIELD

The present disclosure relates to a feature quantity selection device or the like that selects a feature quantity used for estimation.

### BACKGROUND ART

With the spread of Internet of Things (IoT) technology, various information can be collected from various IoT devices. For example, attempts have been made to utilize information collected by IoT devices in fields such as medical care, healthcare, and security. If machine learning is applied to the information collected by IoT devices, the information can be used for applications such as body condition estimation. Since IoT devices are often arranged in places where power supply is difficult, advanced power saving is required. In power consumption of an IoT device, the ratio of power consumption consumed for communication is large. For example, if the information amount of a feature quantity used for estimating a body condition or the like can be reduced, the information amount transmitted from the IoT device can be reduced, and the power consumption of the IoT device can be reduced.

PTL 1 discloses a technique for reducing data that has a weak causal relationship with abnormality prediction of a device from sensor data collected in a factory or the like. PTL 1 discloses a technique for reducing data that has a weak causal relationship by utilizing a plurality of sparse estimation methods. PTL 1 discloses least absolute shrinkage and selection operator regression (also referred to as Lasso regression) as an example of the sparse estimation method. In the method of PTL 1, a plurality of pieces of data to which the sparse estimation method can be applied is used as an input, and each application degree of the plurality of sparse estimation methods is machine-learned for a model that performs predetermined output by applying the plurality of sparse estimation methods. According to the method of PTL 1, an appropriate sparse estimation method can be selected in accordance with the problem, and the degree of sparsity can be adjusted for the selected sparse estimation method.

### CITATION LIST

### Patent Literature

PTL 1: JP 2021-149590 A

### SUMMARY OF INVENTION

### Technical Problem

By using the method of PTL 1, it is also possible to reduce unimportant feature quantities among feature quantities used for estimation of a body condition or the like. For example, by using Lasso regression, an unnecessary feature quantity can be reduced by selecting an important feature quantity among feature quantities used for estimation. However, in a case where the number of subjects is small, the feature quantity selected using Lasso regression is easily affected by jump values and outliers. When jump values and outliers are arbitrarily excluded among a small number of data, effectiveness of the model used for estimation decreases. Thus, it is necessary to select a feature quantity having high robustness against jump values and outliers.

An object of the present disclosure is to provide a feature quantity selection device or the like capable of selecting a feature quantity having high robustness against jump values and outliers.

### Solution to Problem

A feature quantity selection device according to an aspect of the present disclosure includes an acquisition unit that acquire a plurality of data sets, a construction unit that constructs a plurality of re-extracted data sets by changing a distribution of data included in the data set, an analysis unit that analyze the plurality of re-extracted data sets using a Lasso regression method, a statistics unit that aggregates values of elements included in the plurality of re-extracted data sets in accordance with an analysis result of the plurality of re-extracted data sets and setting a logical value to the elements included in the plurality of re-extracted data sets in accordance with an aggregation result of the values of the elements, a selection unit that select a combination of feature quantities in accordance with a value of the logical value set to the elements in accordance with a preset specifying rule, and an output unit that outputs selection information regarding the selected combination of the feature quantities.

A feature quantity estimation method according to an aspect of the present disclosure is to perform acquiring a plurality of data sets, constructing a plurality of re-extracted data sets by changing a distribution of data included in the data set, analyzing the plurality of re-extracted data sets using a Lasso regression method, aggregating values of elements included in the plurality of re-extracted data sets in accordance with an analysis result of the plurality of re-extracted data sets, setting a logical value to the elements included in the plurality of re-extracted data sets in accordance with an aggregation result of the values of the elements, selecting a combination of feature quantities in accordance with a value of the logical value set to the elements in accordance with a preset specifying rule, and outputting selection information regarding the selected combination of the feature quantities.

A program according to an aspect of the present disclosure causes a computer to execute a process of acquiring a plurality of data sets, a process of constructing a plurality of re-extracted data sets by changing a distribution of data included in the data set, a process of analyzing the plurality of re-extracted data sets using a Lasso regression method, a process of aggregating values of elements included in the plurality of re-extracted data sets in accordance with an analysis result of the plurality of re-extracted data sets, a process of setting a logical value to the elements included in the plurality of re-extracted data sets in accordance with an aggregation result of the values of the elements, a process of selecting a combination of feature quantities in accordance with a value of the logical value set to the elements in accordance with a preset specifying rule, and a process of outputting selection information regarding the selected combination of the feature quantities.

### Advantageous Effects of Invention

According to the present disclosure, it is possible to provide a feature quantity selection device or the like capable of selecting a feature quantity having high robustness against jump values and outliers.

### BRIEF DESCRIPTION OF DRAWINGS

FIG. 1 is a block diagram illustrating an example of a configuration of a feature quantity selection device according to a first example embodiment.

FIG. 2 is a conceptual diagram for describing a first matrix generated by the feature quantity selection device according to the first example embodiment.

FIG. 3 is a conceptual diagram for describing a first matrix of a plurality of patterns generated by the feature quantity selection device according to the first example embodiment.

FIG. 4 is a conceptual diagram for describing an aggregated value of cells of the first matrix of the plurality of patterns generated by the feature quantity selection device according to the first example embodiment.

FIG. 5 is a conceptual diagram for describing a second matrix generated by the feature quantity selection device according to the first example embodiment.

FIG. 6 is an estimation example using an estimation model generated using a feature quantity selected by a general Lasso regression method.

FIG. 7 is an estimation example using an estimation model generated using a feature quantity selected by the method of the first example embodiment.

FIG. 8 is a graph for describing an influence of a jump value or an outlier that can be included in sensor data measured for a plurality of subjects.

FIG. 9 is a flowchart for describing an example of operation of the feature quantity selection device according to the first example embodiment.

FIG. 10 is a flowchart for describing an example of the operation of the feature quantity selection device according to the first example embodiment.

FIG. 11 is a block diagram illustrating an example of a configuration of a feature quantity selection device according to a second example embodiment.

FIG. 12 is a flowchart for describing an example of operation of the feature quantity selection device according to the second example embodiment.

FIG. 13 is a flowchart for describing an example of the operation of the feature quantity selection device according to the second example embodiment.

FIG. 14 is a flowchart for describing an example of the operation of the feature quantity selection device according to the second example embodiment.

FIG. 15 is a block diagram illustrating an example of a configuration of a feature quantity selection device according to a third example embodiment.

FIG. 16 is a flowchart for describing an example of operation of the feature quantity selection device according to the third example embodiment.

FIG. 17 is a flowchart for describing an example of the operation of the feature quantity selection device according to the third example embodiment.

FIG. 18 is a block diagram illustrating an example of a configuration of a feature quantity selection device according to a fourth example embodiment.

FIG. 19 is a block diagram illustrating an example of a configuration of a machine learning system according to a fifth example embodiment.

FIG. 20 is a block diagram illustrating an example of a configuration of a machine learning device included in the machine learning system according to the fifth example embodiment.

FIG. 21 is a conceptual diagram for describing an example of machine learning of the machine learning device included in the machine learning system according to the fifth example embodiment.

FIG. 22 is a block diagram illustrating an example of a configuration of a body condition estimation system according to a sixth example embodiment.

FIG. 23 is a block diagram illustrating an example of a configuration of a gait measuring device included in the body condition estimation system according to the sixth example embodiment.

FIG. 24 is a conceptual diagram for describing an arrangement example of the gait measuring device included in the body condition estimation system according to the sixth example embodiment.

FIG. 25 is a conceptual diagram for describing a coordinate system set in the gait measuring device included in the body condition estimation system according to the sixth example embodiment.

FIG. 26 is a conceptual diagram for describing a human body surface used in a description regarding the gait measuring device included in the body condition estimation system according to the sixth example embodiment.

FIG. 27 is a conceptual diagram for describing a gait cycle used in the description regarding the gait measuring device included in the body condition estimation system according to the sixth example embodiment.

FIG. 28 is a graph for describing an example of time-series data of sensor data measured by the gait measuring device included in the body condition estimation system according to the sixth example embodiment.

FIG. 29 is a diagram for describing an example of normalization of gait waveform data extracted from the time-series data of sensor data measured by the gait measuring device included in the body condition estimation system according to the sixth example embodiment.

FIG. 30 is a conceptual diagram for describing an example of a gait phase cluster from which a feature quantity data generation unit of the gait measuring device included in the body condition estimation system according to the sixth example embodiment extracts feature quantities.

FIG. 31 is a block diagram illustrating an example of a configuration of an estimation device included in the body condition estimation system according to the sixth example embodiment.

FIG. 32 is a block diagram illustrating an example of estimation of a score of a body condition by the estimation device included in the body condition estimation system according to the sixth example embodiment.

FIG. 33 is a flowchart for describing an example of operation of the gait measuring device included in the body condition estimation system according to the sixth example embodiment.

FIG. 34 is a flowchart for describing an example of the operation of the estimation device included in the body condition estimation system according to the sixth example embodiment.

FIG. 35 is a conceptual diagram for describing an application example of the body condition estimation system according to the sixth example embodiment.

FIG. 36 is a block diagram illustrating an example of a hardware configuration that executes processing according to each example embodiment.

### EXAMPLE EMBODIMENTS

Hereinafter, example embodiments of the present invention will be described with reference to the drawings. However, although the example embodiments to be described below are technically preferably limited to carry out the present invention, the scope of the invention is not limited to the following. In all the drawings used in the following description of the example embodiment, the same reference numerals are given to similar parts unless there is a particular reason. In the following example embodiments, repeated description of similar configurations and operations may be omitted.

### First Example Embodiment

First, a feature quantity selection device according to a first example embodiment will be described with reference to the drawings. The feature quantity selection device of the present example embodiment selects a feature quantity to be used for estimation of a body condition or the like by using a method of least absolute shrinkage and selection operator (LASSO) regression (hereinafter, referred to as Lasso regression). Lasso regression is also called L1 regularization.

Hereinafter, selection of a feature quantity used for estimation of a body condition will be described. For example, the feature quantity used for estimation of a body condition is extracted based on sensor data regarding movement of the foot according to the gait of the user. For example, the sensor data regarding the movement of the foot is measured by a measuring device installed on the footwear. For example, the measuring device includes an acceleration sensor and an angular velocity sensor. The sensor data is not limited to the sensor data regarding the movement of the foot, and only needs to include a feature regarding the gait. For example, the sensor data may be sensor data including features related to gait measured using motion capture, smart apparel, or the like. The following method can be applied not only to selection of a feature quantity regarding a gait but also to an application of selecting a feature quantity from any sensor data.

### (Configuration)

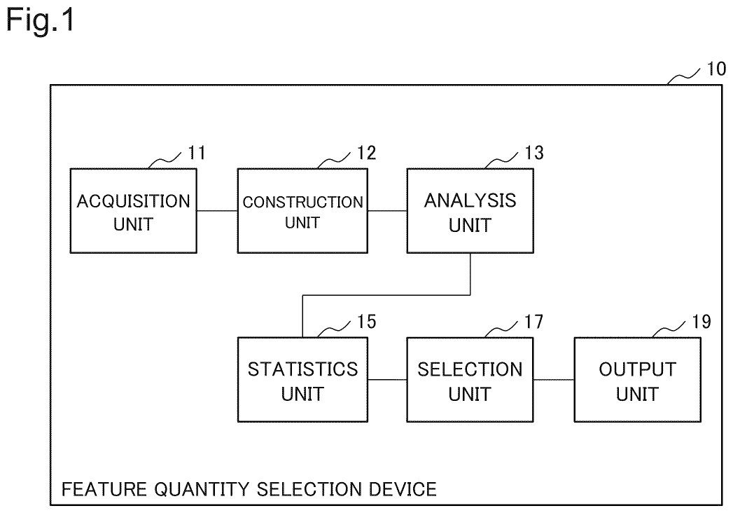

FIG. 1 is a block diagram illustrating an example of a configuration of a feature quantity selection device 10 according to the present example embodiment. The feature quantity selection device 10 includes an acquisition unit 11, a construction unit 12, an analysis unit 13, a statistics unit 15, a selection unit 17, and an output unit 19.

The acquisition unit 11 acquires a data set used for estimation of a body condition measured for a plurality of subjects. The data set is data in which an explanatory variable and an objective variable corresponding to the explanatory variable are combined. For example, the data set is data in which measurement values and feature quantities related to the subject are associated with the body condition of the subject. For example, the explanatory variable used for the estimation of the body condition is a feature quantity extracted from sensor data regarding the movement of the foot and the gait.

The construction unit 12 constructs a new data set (also referred to as a re-extracted data set) by changing the distribution of the data sets related to a plurality of subjects. For example, the construction unit 12 constructs the re-extracted data set using the Leave-One-Subject-Out (also referred to as LOSO) method. When the LOSO method is used, one is removed from a plurality of data sets, and a reconstructed data set is constructed using the remaining data sets. When the LOSO method is used, the reconstructed data set is generated by the number of subjects. For example, if there are 50 subjects, the LOSO approach can be used to construct 50 re-extracted data sets.

The construction unit 12 may construct the re-extracted data set using a bootstrap method. In the bootstrap method, the nature of the population is estimated based on a value randomly extracted from the sample population by the restoration extraction method. In the bootstrap method, generation of a new data set using values randomly extracted from the sample population is repeated, and a statistical value is calculated. For example, after 1000 iterations of generating new data sets, 1000 re-extracted data sets can be constructed.

The analysis unit 13 performs Lasso regression for the re-extracted data set constructed by the construction unit 12. For example, the analysis unit 13 uses a loss function represented by the following Expression 1.

$$[ Math . 1 ]$$

$$L = \frac{1}{2 N} {\sum }_{i = 1}^{N} {( {y}_{i} - {β}_{0} - {x}_{i}^{T} β )}^{2} + λ {\sum }_{j = 1}^{p} \vert {β}_{j} \vert \qquad ( 1 )$$

In Expression 1 above, N is the number of observations. i is a number of an observation value. xᵢ is a vector (data) having a length p at an observation value i. yᵢ is response data (correct answer value) of the observation value i. λ is a non-negative regularization parameter (Lagrange multiplier) corresponding to one value. β₀ is a scalar. β is a vector having a length p. j is a feature quantity number. When the feature quantity is p, the feature quantity number j is one of 1 to p. βⱼ corresponds to a coefficient (also referred to as a model parameter) of a polynomial function used as an estimation model. T represents transposition processing.

The first term on the right side of Expression 1 is a term relating to a sum of squares error. The second term on the right side of Expression 1 is a regularization term. The regularization term is a function defined to return a larger value as the model parameter βⱼ increases. The regularization term corresponds to a penalty for the magnitude of the model parameter βⱼ.

The regularization parameter λ is a meta parameter set at the time of machine learning the model. The regularization parameter λ adjusts the strength of the regularization (penalty). When the value of the regularization parameter λ is large, the penalty of the regularization term becomes strong, and over-learning is more strongly suppressed. When the value of the regularization parameter λ is too large, priority is given to keeping the model parameter small, and the expressive power of the model decreases. As a result, when the value of the regularization parameter λ is too large, a large bias remains.

In accordance with the setting of the regularization parameter λ, the problem of the following Expression 2 is solved in the Lasso regression.

$$[ Math . 2 ]$$

$${min}_{{β}_{0} , β} ( \frac{1}{2 N} {\sum }_{i = 1}^{N} {( {y}_{i} - {β}_{0} - {x}_{i}^{T} β )}^{2} + λ {\sum }_{j = 1}^{p} \vert {β}_{j} \vert ) \qquad ( 2 )$$

The above Expression 2 indicates a minimum value in a case where β₀ and the coefficient vector B are variables. Expression 2 determines the magnitude of the second term (normalization term) related to the penalty in accordance with the magnitude of the absolute value of the model parameter βⱼ.

The following Expression 3 is a limiting condition for each element of the coefficient vector.

$$[ Math . 3 ]$$

$${\sum }_{j = 1}^{p} \vert {β}_{j} \vert = 0 \qquad ( 3 )$$

When the coefficient vector β of multiple regression is obtained by a least squares method, the above Expression 2 corresponds to obtaining the model parameter βⱼ when the limiting condition of Expression 3 is provided for each element (model parameter βⱼ) of the coefficient vector β.

The regularization parameter λ has one related coefficient vector β. As the regularization parameter λ increases, non-zero elements of the coefficient vector β decrease. That is, when the regularization parameter λ increases, the number of zero elements of the coefficient vector β increases, and unnecessary feature quantities increase. On the other hand, when the regularization parameter λ decreases, the number of non-zero elements of the coefficient vector B increases, and the required feature quantity increases. If an appropriate regularization parameter λ is set, it is possible to reduce unnecessary zero elements while leaving non-zero elements necessary for estimation.

The analysis unit 13 performs Lasso regression for the re-extracted data set constructed by the construction unit 12. The analysis unit 13 changes the regularization parameter 2 for the re-extracted data set for each subject and executes Lasso regression. The analysis unit 13 generates a matrix (also referred to as a first matrix) including columns of the number of regularization parameters λ and rows of the number of feature quantities. For example, when the number of regularization parameters λ is P, numbers of 1 to P (also referred to as λ numbers) are given to respective regularization parameters λ (P is a natural number). The first matrix has rows of the number of feature quantities used for estimation of the body condition or the like. In a case where the number of feature quantities is p, numbers of 1 to p (also referred to as feature quantity numbers) are given to respective feature quantities (p is a natural number).

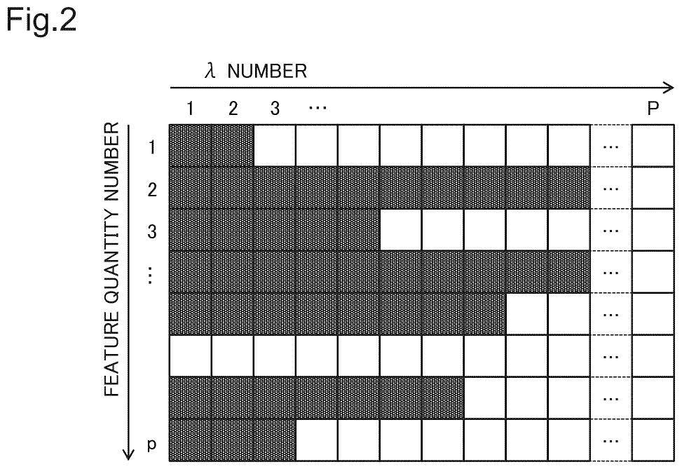

FIG. 2 is a conceptual diagram illustrating an example of a first matrix. In the first matrix of FIG. 2, a hatched cell indicates a non-zero element. In the first matrix of FIG. 2, a blank cell that is not hatched indicates a zero element.

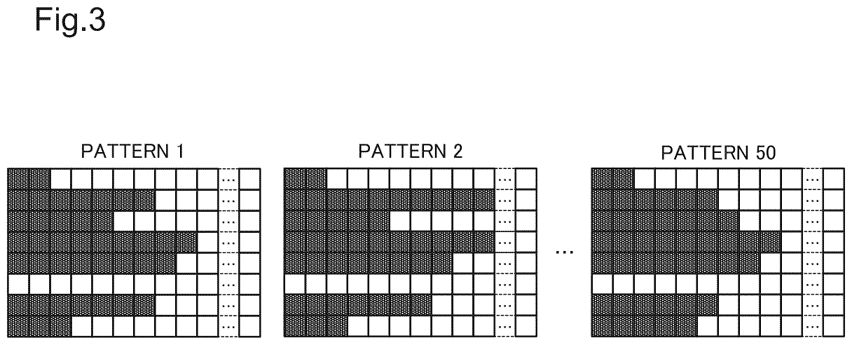

FIG. 3 is an example of a first matrix generated for 50 subjects using the reconstructed data set constructed by LOSO. When the reconstructed data set is constructed by LOSO, a first matrix for each subject is generated. In the example of FIG. 3, the first matrix of 50 patterns is generated in accordance with the number of subjects (50 subjects). In the first matrix of FIG. 3, a hatched cell indicates a non-zero element. In the first matrix of FIG. 3, a blank cell that is not hatched indicates a zero element.

The statistics unit 15 assigns a logical value (0, 1) to each cell of the generated first matrix of the plurality of patterns. The processing of assigning a logical value (0, 1) to each cell of the first matrix of the plurality of patterns generated by the Lasso regression is also referred to as first statistical processing. In the first statistical processing, the statistics unit 15 sets a non-zero element to TRUE (1) and a zero element to FALSE (0) for a plurality of first matrices. The statistics unit 15 aggregates logical values (0, 1) for each cell for all the first matrices. The statistics unit 15 adds a logical values (1) of non-zero elements for each cell for all the first matrices, thereby aggregating the logical values (0, 1) for each cell.

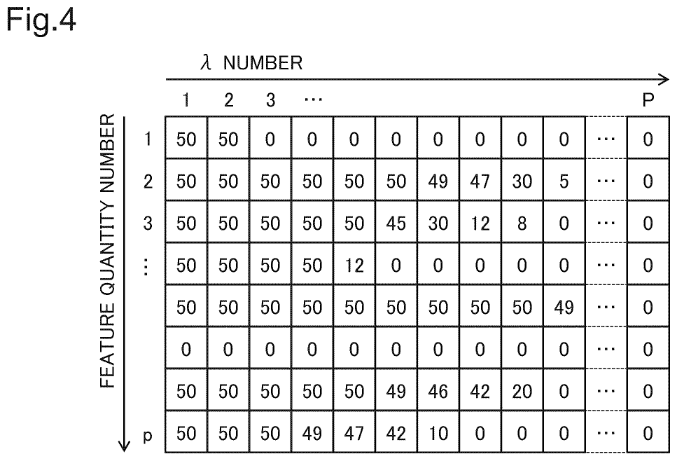

FIG. 4 illustrates an example in which an aggregated value of logical values related to the first matrix of the 50 test subjects is filled in each cell of a matrix (also referred to as a second matrix) corresponding to all the first matrices. In each cell of the second matrix, the number of non-zero elements (the number of TRUE) of the first matrix is filled for the plurality of patterns.

The statistics unit 15 assigns a logical value (0 or 1) to each cell of the second matrix in accordance with the aggregated value of each cell included in all the first matrices. When the aggregated value for each cell in the second matrix is equal to or more than a predetermined threshold, the statistics unit 15 sets the cell to TRUE (1). On the other hand, when the aggregated value is less than the predetermined threshold, the statistics unit 15 sets the cell to FALSE (0). The processing of aggregating logical values (0, 1) for each cell for all the first matrices and assigning a logical value (0 or 1) corresponding to the aggregated value to each cell of the second matrix is also referred to as second statistical processing.

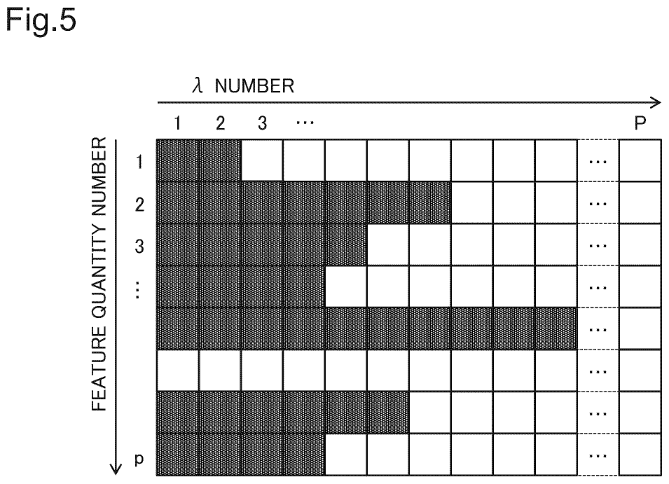

FIG. 5 is a conceptual diagram illustrating an example in which a logical value (0 or 1) is assigned to the aggregated values in FIG. 4. In the example of FIG. 5, a cell in which the aggregated value is equal to or more than 49 in FIG. 4 is set to TRUE (1). In the example of FIG. 5, cells set to TRUE (1) by the second statistical processing are hatched. In the example of FIG. 5, cells set to FALSE (0) by the second statistical processing are blank. For example, the result of the second statistical processing as illustrated in FIG. 5 may be displayed on a screen that can be confirmed by the user. In this case, the user can select a desired combination of feature quantities by selecting a A number according to the result of the second statistical processing displayed on the screen.

The statistics unit 15 may assign a logical value corresponding to an average value of the aggregated values to each cell of the second matrix. For example, with respect to each cell of the second matrix, the statistics unit 15 sets a cell in which the average value of the aggregated values is equal to or more than a predetermined threshold to TRUE (1). On the other hand, the statistics unit 15 sets a cell in which the average value of the aggregated values is less than the predetermined threshold to FALSE (0). Such a process is also included in the second statistical processing.

The selection unit 17 selects a A number in accordance with a preset specifying rule. The specifying rule is a rule for determining a x number to be selected. For example, the specifying rule is a rule of selecting a λ number in which the number of cells set to TRUE (1) corresponds to a preset reference value. The reference value may be set in accordance with constraints of a calculation amount and a communication amount. For example, the reference value is set to a value that does not exceed a load that can be assigned to the calculation amount or the communication amount. For example, the reference value is set to a value that does not exceed a ratio (for example, 50 to 80%, and the like) to the load that can be assigned to the calculation amount or the communication amount. For example, when there is a plurality of λ numbers in which the number of cells set to TRUE (1) corresponds to the reference value, it is only required to select at least one λ number. The selection unit 17 selects a combination of feature quantities in which the cell of the selected λ number is set to TRUE (1) based on the specifying rule. For example, the selection unit 17 may select a combination of feature quantities in accordance with a reference value set by the user.

The output unit 19 outputs information (also referred to as selection information) regarding the feature quantity selected by the selection unit 17. The selection information is information regarding a combination of feature quantities used for estimation of the body condition or the like. For example, in the case of the sensor data regarding movement of the foot, the selection information includes information indicating from which gait phase the feature quantity is extracted in the time-series data of the acceleration and the angular velocity for one gait cycle. The gait phase indicates a gait cycle (percentage) when one gait cycle is normalized to 0 to 100%. Feature quantities over a plurality of continuous gait phases may be extracted. The mass of a plurality of continuous gait phases from which the feature quantity is extracted is also called a gait phase cluster.

The selection information output from the output unit 19 is used as a condition for extracting a feature quantity from sensor data measured by a measuring device or the like. For example, the selection unit 17 may cause the selection information to be stored in a storage unit, which is not illustrated. For example, the feature quantity extracted in accordance with the selection information is used for machine learning of an estimation model for estimating the body condition or the like. For example, the feature quantity of the extraction target is extracted from sensor data measured by the measuring device or the like worn by the user who is a body condition estimation target.

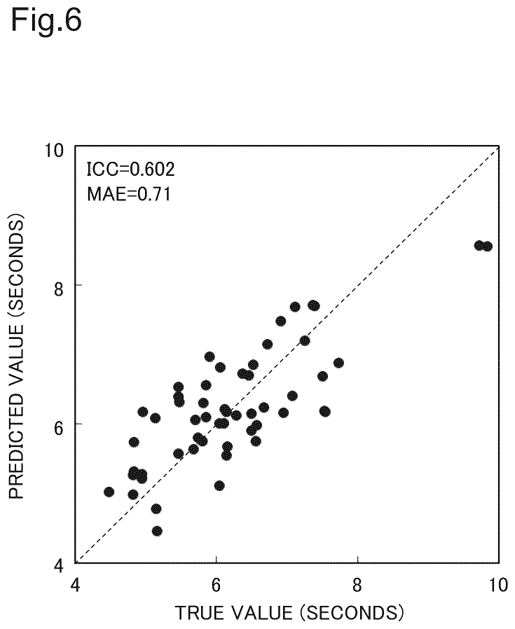

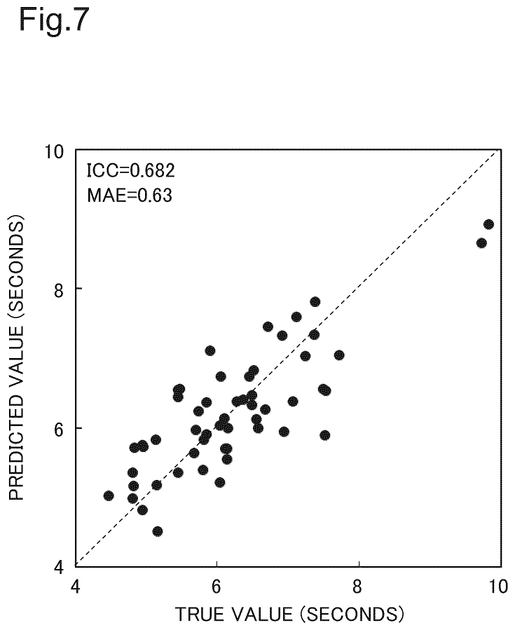

FIGS. 6 to 7 are conceptual diagrams for describing a difference in an estimated value by an estimation model generated by machine learning using a feature quantity selected using a general Lasso regression (comparative example) method and a feature quantity selected using the method of the present example embodiment. FIGS. 6 to 7 are examples in which a score of a time up and go (TUG) test is estimated as the mobility of the subject. The score of the TUG test is the time (also referred to as TUG required time) from standing up from a chair and walking to a mark 3 meters ahead to change the direction to sit down again on the chair.

FIG. 6 illustrates an estimation example using an estimation model generated using nine feature quantities selected by a general Lasso regression (comparative example) method. With respect to the true value (measurement value) and the estimated value of the TUG required time, the correlation intraclass correlation coefficient ICC was 0.602. With respect to the true value (measurement value) and the estimated value of the TUG required time, the mean absolute error (MAE) was 0.71.

FIG. 7 is an estimation example using an estimation model generated using nine feature quantities selected by the method of the present example embodiment. In the example of FIG. 7, the re-extracted data set constructed by LOSO was used. With respect to the true value (measurement value) and the estimated value of the TUG required time, the correlation intraclass correlation coefficient ICC was 0.682. With respect to the true value (measurement value) and the estimated value of the TUG required time, the average absolute error MAE was 0.63. As described above, both the ICC and the MAE were larger when the method of the present example embodiment was used. That is, by using the method of the present example embodiment, robustness against jump values and outliers is improved.

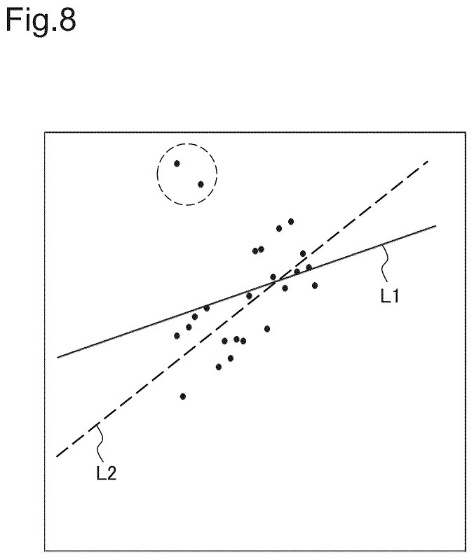

FIG. 8 is a graph for describing an influence of a jump value or an outlier that can be included in sensor data measured for a plurality of subjects. Data within a range surrounded by a broken line circle corresponds to a jump value or an outlier. L1 is a regression line when a plurality of pieces of sensor data is linearly regressed, including jump values and outliers. L2 is a regression line when a plurality of pieces of sensor data is linearly regressed while arbitrarily excluding a jump value and an outlier. The regression line L1 is affected by the jump values or outliers and does not fit the majority of sensor data. On the other hand, the regression line L2 is not affected by jump values or outliers, and fits the majority of sensor data. When the regression line L1 and the regression line L2 are compared with each other, it is likely that a more accurate estimation model can be constructed by using the regression line L2 from which the jump value and the outlier are arbitrarily excluded. However, if the jump values and outliers are arbitrarily excluded, effectiveness of the estimation model decreases. Thus, it is necessary to select a feature quantity having high robustness against a jump value or an outlier without reducing the effectiveness of the estimation model.

In the method of the present example embodiment, Lasso regression is performed after changing the distribution of the data set using a method such as LOSO or a bootstrap method. In the method of the present example embodiment, the first statistical processing and the second statistical processing described above are executed in addition to simply combining a method such as LOSO or a bootstrap method and Lasso regression. As a result, according to the method of the present example embodiment, an average solution in which the influence of jump values and outliers is reduced is obtained. According to the method of the present example embodiment, it is possible to select a feature quantity having high robustness against a jump value or an outlier without reducing the effectiveness of the estimation model.

### (Operation)

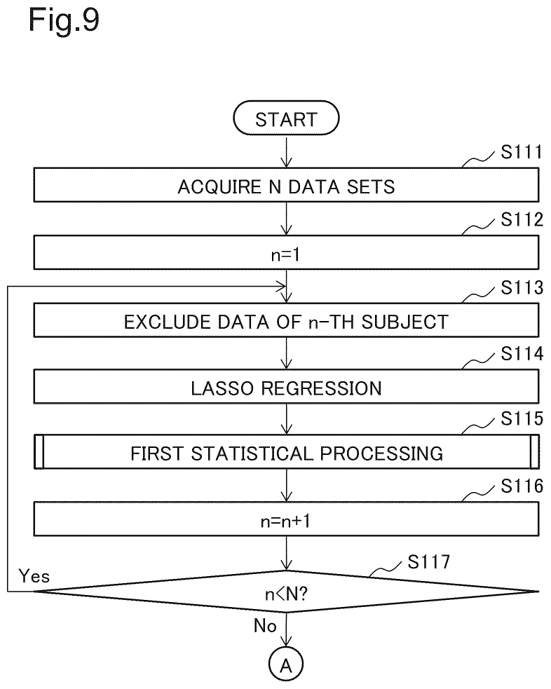

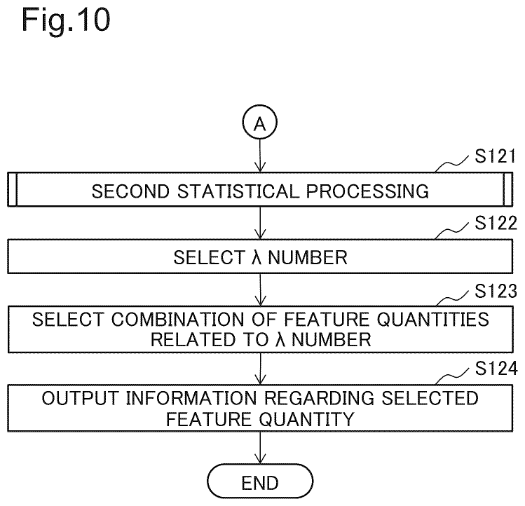

Next, operation of the feature quantity selection device 10 of the present example embodiment will be described with reference to the drawings. FIGS. 9 and 10 are flowcharts for describing an example of operation of the feature quantity selection device 10. In the description using the flowcharts of FIGS. 9 and 10, the feature quantity selection device 10 will be described as an operation subject.

In FIG. 9, first, the feature quantity selection device 10 acquires N data sets (step S111). The number of the data set corresponds to the number (feature quantity number) of the explanatory variable (feature quantity) included in the data set.

Next, the feature quantity selection device 10 sets the feature quantity number n to 1 (step S112). n is a number of a data set (feature quantity).

Next, the feature quantity selection device 10 excludes data of the n-th subject (step S113).

Next, the feature quantity selection device 10 performs Lasso regression for N−1 data sets from which the data of the n-th subject is excluded (step S114).

Next, the feature quantity selection device 10 executes first statistical processing (step S115). As the first statistical processing, the feature quantity selection device 10 assigns a logical value to each cell of the first matrix (matrix Bₙ) generated by Lasso regression. For example, the feature quantity selection device 10 sets the non-zero elements of the matrix Bₙ to TRUE (1) and sets the zero element of the matrix Bₙ to FALSE (0). For example, the feature quantity selection device 10 may set a cell in which a value of an element of the matrix Bₙ is equal to or more than the threshold T₀ to TRUE (1), and a cell in which a value of an element of the matrix Bₙ is less than the threshold T₀ to FALSE (0). Next, the feature quantity selection device 10 increments (+1) the feature quantity number n (step S116).

Here, when the feature quantity number n is smaller than the number N of data sets (Yes in step S117), the process returns to step S113. On the other hand, when the feature quantity number n is equal to or more than the number N of data sets (No in step S117), the process proceeds to step S121 in FIG. 10.

When it is No in step S117 in FIG. 9, the feature quantity selection device 10 executes second statistical processing (step S121). As the second statistical processing, the feature quantity selection device 10 aggregates logical values (0 or 1) for each cell for all the first matrices. The feature quantity selection device 10 sets a logical value (0 or 1) to each cell of the aggregated second matrix in accordance with the relationship between the aggregated value of the logical value for each cell and the predetermined threshold. For example, the feature quantity selection device 10 sets a cell in which the aggregated value is equal to or more than a predetermined threshold to TRUE (1). On the other hand, the feature quantity selection device 10 sets a cell having an aggregated value is less than the predetermined threshold to FALSE (0).

Next, the feature quantity selection device 10 selects the A number based on the specifying rule in accordance with the result of the second statistical processing (step S122).

Next, the feature quantity selection device 10 selects a combination of feature quantities related to the selected λ number (step S123).

Next, the feature quantity selection device 10 outputs information (selection information) regarding the selected feature quantity (step S124). The selection information output from the feature quantity selection device 10 is used as a condition for extracting a feature quantity from sensor data measured by the measuring device or the like.

As described above, the feature quantity selection device of the present example embodiment includes the acquisition unit, the construction unit, the analysis unit, the statistics unit, the selection unit, and the output unit. The acquisition unit acquires a plurality of data sets. The construction unit constructs a plurality of re-extracted data sets by changing the distribution of the data included in the data set. The analysis unit analyzes a plurality of re-extracted data sets using a Lasso regression method. The statistics unit aggregates values of elements included in the plurality of re-extracted data sets in accordance with the analysis results of the plurality of re-extracted data sets. The statistics unit sets logical values to elements included in the plurality of re-extracted data sets in accordance with the aggregation result of the values of the elements. The selection unit selects the feature quantity of the combination according to the value of the logical value set for the element in accordance with a preset specifying rule. The output unit outputs selection information on the selected combination of the feature quantities.

In the present example embodiment, the analysis unit executes Lasso regression for each of a plurality of preset regularization parameters for a plurality of re-extracted data sets. The analysis unit generates the first matrix of the plurality of patterns including a column related to the regularization parameter used in the Lasso regression and a row related to the feature quantity. The statistics unit executes first statistical processing of setting a first logical value of a non-zero element cell to 1 and setting a first logical value of a zero element cell to 0 for a first matrix of a plurality of patterns. The statistics unit aggregates the first logical values for each cell constituting the first matrix of the plurality of patterns. The statistics unit executes second statistical processing of generating a second matrix in which 1 is set as a second logical value to a cell in which the aggregated value of the first logical values satisfies a predetermined condition, and 0 is set as a second logical value to a cell in which the aggregated value of the first logical values does not satisfy the predetermined condition. The selection unit selects a column of the second matrix in accordance with a preset specifying rule, and selects a combination of feature quantities related to the selected column.

According to the present example embodiment, by performing Lasso regression by changing the distribution of data, it is possible to obtain a feature quantity having an average value closer to a true value as compared with a case where the influence of a jump value or an outlier is directly received. Thus, according to the present example embodiment, it is possible to select a feature quantity having high robustness against a jump value or an outlier.

In an aspect of the present example embodiment, the construction unit constructs a plurality of re-extracted data sets using the Leave-One-Subject-Out method. According to the present aspect, by artificially changing the data distribution using the Leave-One-Subject-Out method, it is possible to bring the data distribution closer to the population distribution that should originally exist.

In an aspect of the present example embodiment, the construction unit constructs a plurality of re-extracted data sets using the bootstrap method. According to the present aspect, the distribution of data can be brought close to the distribution of the population estimated from the sample population by artificially changing the distribution of data using the bootstrap method.

In an aspect of the present example embodiment, in the second statistical processing, the statistics unit calculates a total value of the first logical values for each cell constituting the first matrix of the plurality of patterns. The statistics unit generates a second matrix in which second logical values of the cells in which the total value of the first logical values is equal to or more than a predetermined threshold are set to 1 and the cells in which the total value of the first logical values is less than the predetermined threshold are set to 0. According to the present aspect, a combination of feature quantities can be selected based on the logical values of the second matrix set in accordance with the total value of the first logical values.

In an aspect of the present example embodiment, in the second statistical processing, the statistics unit calculates an average value of the first logical values for each cell constituting the first matrix of the plurality of patterns. The statistics unit generates a second matrix in which the second logical value of the cell in which the average value of the first logical values is equal to or more than a predetermined threshold is set to 1 and the cell in which the average value of the first logical values is less than the predetermined threshold is set to 0. According to the present aspect, a combination of feature quantities can be selected based on the logical values of the second matrix set in accordance with the average value of the first logical values.

### Second Example Embodiment

Next, a feature quantity selection device according to a second example embodiment will be described with reference to the drawings. The feature quantity selection device of the present example embodiment constructs an estimation model using a feature quantity selected by the method of the first example embodiment. The feature quantity selection device of the present example embodiment selects a feature quantity in accordance with an estimation result of a constructed estimation model.

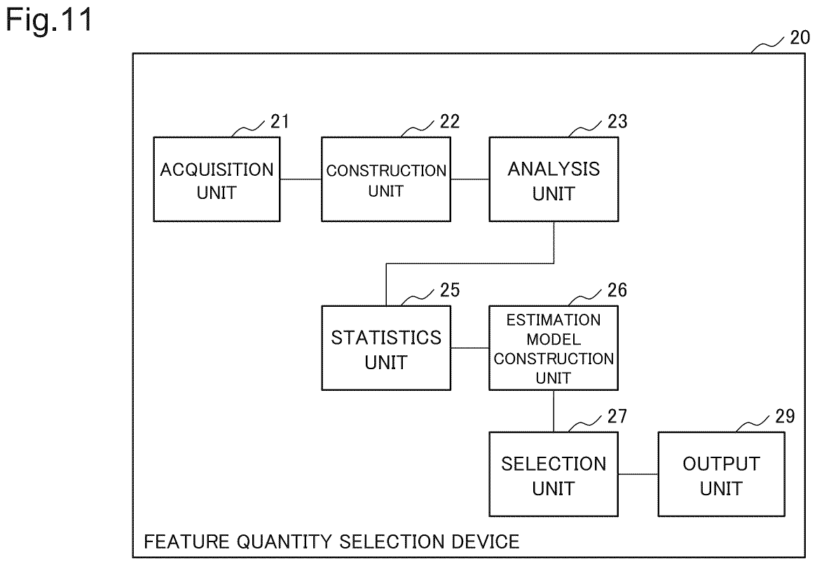

FIG. 11 is a block diagram illustrating an example of a configuration of the feature quantity selection device 20 according to the present example embodiment. The feature quantity selection device 20 includes an acquisition unit 21, a construction unit 22, an analysis unit 23, a statistics unit 25, an estimation model construction unit 26, a selection unit 27, and an output unit 29.

The acquisition unit 21 has a configuration similar to that of the acquisition unit 11 of the first example embodiment. The acquisition unit 21 acquires a data set used for estimation of the body condition measured for a plurality of subjects.

The construction unit 22 has a configuration similar to that of the construction unit 12 of the first example embodiment. The construction unit 22 constructs a new data set (also referred to as a re-extracted data set) by changing a distribution of data sets related to a plurality of subjects. For example, the construction unit 22 constructs the re-extracted data set using the Leave-One-Subject-Out (also referred to as LOSO) method. For example, the construction unit 12 may construct the re-extracted data set using the bootstrap method.

The analysis unit 23 has a configuration similar to that of the analysis unit 13 of the first example embodiment. The analysis unit 23 performs Lasso regression for the re-extracted data set constructed by the construction unit 22. The analysis unit 23 generates a matrix (also referred to as a first matrix) including columns of the number of regularization parameters λ and rows of the number of feature quantities. As a result, the first matrix having the number of columns of the changed regularization parameter λ is generated.

The statistics unit 25 has a configuration similar to that of the statistics unit 15 of the first example embodiment. The statistics unit 25 executes first statistical processing of assigning a logical value (0, 1) to each cell of the first matrix of a plurality of patterns generated for each subject. In the first statistical processing, the statistics unit 25 sets a non-zero element to TRUE (1) and a zero element to FALSE (0) for a plurality of first matrices.

The statistics unit 25 performs second statistical processing of aggregating logical values (0, 1) for each cell for all the first matrices and adding a logical value (1) of the non-zero element for each cell. The statistics unit 25 assigns a logical value (0 or 1) to each cell of the second matrix in accordance with the aggregated value of each cell of the first matrix. For each cell in the second matrix, when the aggregated value is equal to or more than the predetermined threshold, the statistics unit 25 sets the cell to TRUE (1). On the other hand, when the aggregated value is less than the predetermined threshold, the statistics unit 25 sets the cell to FALSE (0).

The estimation model construction unit 26 constructs an estimation model by machine learning using the feature quantity selected by the selection unit 27. The estimation model construction unit 26 evaluates the constructed estimation model. For example, the estimation model construction unit 26 calculates evaluation indexes such as a mean square error, a mean absolute error, a mean relative error, a determination coefficient, and a correlation coefficient. The estimation model construction unit 26 outputs the calculated evaluation index to the selection unit 27. For example, an evaluation result of the estimation model may be displayed on a screen that can be confirmed by the user. In this case, the user can select a combination of maximum likelihood feature quantities in accordance with the evaluation result displayed on the screen.

The selection unit 27 selects a combination of feature quantities having the highest evaluation index calculated by the estimation model construction unit 26. For example, the selection unit 27 may select maximum likelihood feature quantities in accordance with an instruction input by the user.

The output unit 29 has a configuration similar to that of the output unit 19 of the first example embodiment. The output unit 29 outputs information (also referred to as selection information) regarding the feature quantity selected by the selection unit 27. The selection information output from the output unit 29 is used as a condition for extracting a feature quantity from sensor data measured by the measuring device or the like. For example, the selection unit 27 may store the selection information in a storage unit, which is not illustrated. For example, the feature quantity extracted in accordance with the selection information is used for machine learning of the estimation model for estimating the body condition or the like. For example, the feature quantity of the extraction target is extracted from sensor data measured by the measuring device or the like worn by the user who is a body condition estimation target.

### (Operation)

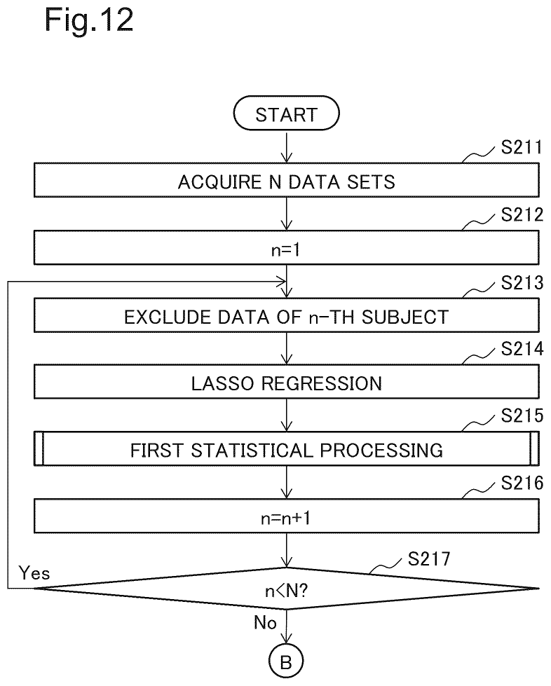

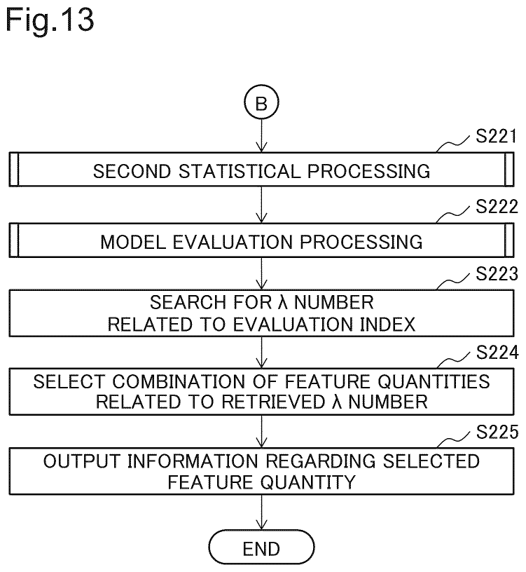

Next, operation of the feature quantity selection device 20 of the present example embodiment will be described with reference to the drawings. FIGS. 12 to 13 are flowcharts for describing an example of operation of the feature quantity selection device 20. In the description using the flowcharts of FIGS. 12 to 13, the feature quantity selection device 20 will be described as an operation subject.

In FIG. 12, first, the feature quantity selection device 20 acquires N data sets (step S211). The number of the data set corresponds to the number (feature quantity number) of the explanatory variable (feature quantity) included in the data set.

Next, the feature quantity selection device 20 sets the feature quantity number n to 1 (step S212). n is a number of a data set (feature quantity).

Next, the feature quantity selection device 20 excludes data of the n-th subject (step S213).

Next, the feature quantity selection device 20 performs Lasso regression for N−1 data sets from which the data of the n-th subject is excluded (step S214).

Next, the feature quantity selection device 20 executes first statistical processing (step S215). As the first statistical processing, the feature quantity selection device 20 assigns a logical value to each cell of the first matrix (matrix Bₙ) generated by Lasso regression. For example, the feature quantity selection device 20 sets the non-zero elements of the matrix Bₙ to TRUE (1) and sets the zero element of the matrix Bₙ to FALSE (0). For example, the feature quantity selection device 20 may set a cell in which a value of an element of the matrix Bₙ is equal to or more than the threshold T₀ to TRUE (1), and a cell in which a value of an element of the matrix Bₙ is less than the threshold T₀ to FALSE (0).

Next, the feature quantity selection device 20 increments (+1) the feature quantity number n (step S216).

Here, when the feature quantity number n is smaller than the number N of data sets (Yes in step S217), the process returns to step S213. On the other hand, when the feature quantity number n is equal to or more than the number N of data sets (No in step S217), the process proceeds to step S221 in FIG. 13.

If No in step S217 of FIG. 12, the feature quantity selection device 20 executes the second statistical processing (step S221). As the second statistical processing, the feature quantity selection device 20 aggregates logical values (0, 1) for each cell for all the first matrices. The feature quantity selection device 20 assigns a sum of logical values related to each cell of the aggregated first matrix to each cell of the second matrix. The feature quantity selection device 20 sets a logical value (0 or 1) to each cell of the aggregated second matrix in accordance with the value of each cell of the second matrix. For example, the feature quantity selection device 20 sets a cell having an aggregated value equal to or more than a predetermined threshold to TRUE (1). On the other hand, the feature quantity selection device 20 sets a cell having an aggregated value is less than the predetermined threshold to FALSE (0).

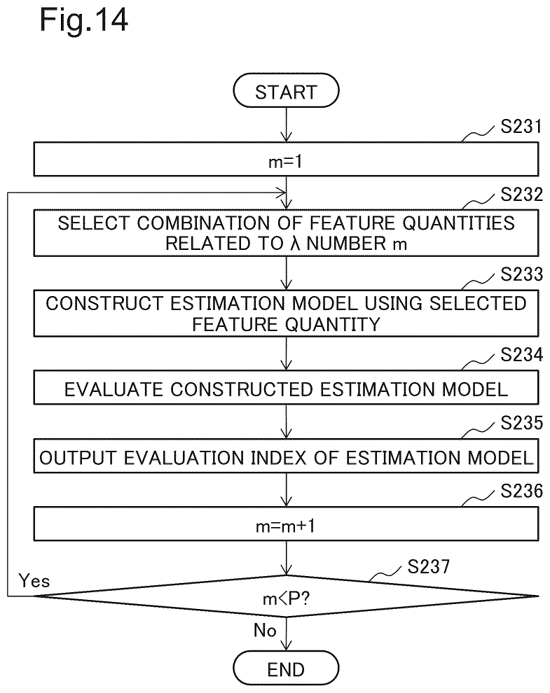

Next, the feature quantity selection device 20 executes model evaluation processing (step S222). The model evaluation processing in step S222 will be described later (FIG. 14).

Next, the feature quantity selection device 20 searches for a 2 number according to the evaluation index obtained by the model evaluation processing (step S223).

Next, the feature quantity selection device 20 selects a combination of feature quantities related to the retrieved λ number (step S224).

Next, the feature quantity selection device 20 outputs information (selection information) regarding the selected feature quantity (step S225). The selection information output from the feature quantity selection device 20 is used as a condition for extracting a feature quantity from sensor data measured by the measuring device or the like.

### [Model Evaluation Processing]

Next, the model evaluation processing in step S222 in FIG. 13 will be described with reference to the drawings. FIG. 14 is a flowchart for describing the model evaluation processing. In the description using the flowchart of FIG. 14, the feature quantity selection device 20 will be described as an operation subject.

In FIG. 14, first, the feature quantity selection device 20 sets A number m to 1 (step S231). m is a number of the regularization parameter λ.

Next, the feature quantity selection device 20 selects a combination of feature quantities related to the λ number m (step S232).

Next, the feature quantity selection device 20 constructs an estimation model using the selected feature quantity (step S233).

Next, the feature quantity selection device 20 evaluates the constructed estimation model (step S234).

Next, the feature quantity selection device 20 outputs the evaluation index of the estimation model (step S235).

Next, the feature quantity selection device 20 increments the λ number m (+1) (step S236).

Here, when λ number m is smaller than the number P of regularization parameters λ (Yes in step S237), the process returns to step S232. On the other hand, when A number m is equal to or more than the number P of regularization parameters λ (Yes in step S237), the process proceeds to step S223 in FIG. 13.

As described above, the feature quantity selection device of the present example embodiment includes the acquisition unit, the construction unit, the analysis unit, the statistics unit, the selection unit, the estimation model construction unit, and the output unit. The acquisition unit acquires a plurality of data sets. The construction unit constructs a plurality of re-extracted data sets by changing the distribution of the data included in the data set. The analysis unit analyzes a plurality of re-extracted data sets using a Lasso regression method. The statistics unit aggregates values of elements included in the plurality of re-extracted data sets in accordance with the analysis results of the plurality of re-extracted data sets. The statistics unit sets logical values to elements included in the plurality of re-extracted data sets in accordance with the aggregation result of the values of the elements. The selection unit selects the feature quantity of the combination according to the value of the logical value set for the element in accordance with a preset specifying rule. The estimation model construction unit constructs an estimation model by machine learning using the selected feature quantity, and evaluates the constructed estimation model. The selection unit selects a combination of feature quantities in accordance with the evaluation result of the estimation model. The output unit outputs selection information on the selected combination of the feature quantities.

In the present example embodiment, the feature quantity is selected in accordance with the evaluation result of the estimation model constructed using the feature quantity selected by the selection unit. Thus, according to the present example embodiment, it is possible to select a highly reliable feature quantity by using the evaluation result of the estimation model.

### Third Example Embodiment

Next, a feature quantity selection device according to a third example embodiment will be described with reference to the drawings. The feature quantity selection device of the present example embodiment is different from that of the first example embodiment in that the first statistical processing is omitted and the second statistical processing is executed on the average value of each cell regarding the plurality of first matrices.

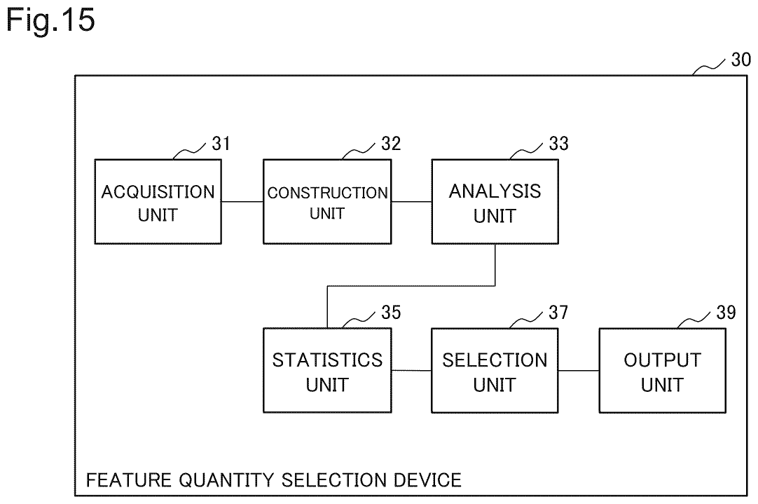

FIG. 15 is a block diagram illustrating an example of a configuration of the feature quantity selection device 30 according to the present example embodiment. The feature quantity selection device 30 includes an acquisition unit 31, a construction unit 32, an analysis unit 33, a statistics unit 35, a 3 selection unit 37, and an output unit 39.

The acquisition unit 31 has a configuration similar to that of the acquisition unit 11 of the first example embodiment. The acquisition unit 31 acquires a data set used for estimation of the body condition measured for a plurality of subjects.

The construction unit 32 has a configuration similar to that of the construction unit 12 of the first example embodiment. The construction unit 32 constructs a new data set (also referred to as a re-extracted data set) by changing a distribution of data sets related to a plurality of subjects. For example, the construction unit 32 constructs the re-extracted data set using the Leave-One-Subject-Out (also referred to as LOSO) method. For example, the construction unit 32 may construct the re-extracted data set using the bootstrap method.

The analysis unit 33 has a configuration similar to that of the analysis unit 13 of the first example embodiment. The analysis unit 33 performs Lasso regression for the re-extracted data set constructed by the construction unit 32. The analysis unit 33 generates a matrix (also referred to as a first matrix) including columns of the number of regularization parameters λ and rows of the number of feature quantities. As a result, the first matrix having the number of columns of the changed regularization parameter λ is generated.

The statistics unit 35 calculates an average value of each cell for the first matrix of the plurality of patterns generated for each subject. The statistics unit 35 generates a second matrix in which the average value of each cell is assigned to each cell of the first matrix of the plurality of patterns. For example, with respect to each cell of the second matrix, the statistics unit 35 sets a cell in which the average value of the aggregated values is equal to or more than a predetermined threshold to TRUE (1). On the other hand, the statistics unit 35 sets a cell in which the average value of the aggregated values is less than the predetermined threshold to FALSE (0). This process is included in the second statistical processing.

The selection unit 37 has a configuration similar to that of the selection unit 17 of the first example embodiment. The selection unit 17 selects the A number based on a preset specifying rule. The selection unit 17 selects a combination of feature quantities in which the cell of the selected A number is set to TRUE (1) based on the specifying rule.

The output unit 39 has a configuration similar to that of the output unit 19 of the first example embodiment. The output unit 39 outputs information (also referred to as selection information) regarding the feature quantity selected by the selection unit 27. The selection information output from the output unit 39 is used as a condition for extracting a feature quantity from sensor data measured by the measuring device or the like. For example, the selection unit 37 may store the selection information in a storage unit, which is not illustrated. For example, the feature quantity extracted in accordance with the selection information is used for machine learning of the estimation model for estimating the body condition or the like. For example, the feature quantity of the extraction target is extracted from sensor data measured by the measuring device or the like worn by the user who is a body condition estimation target.

### (Operation)

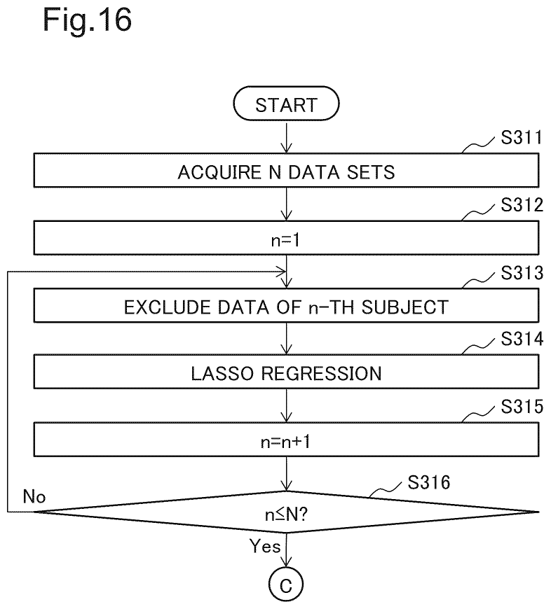

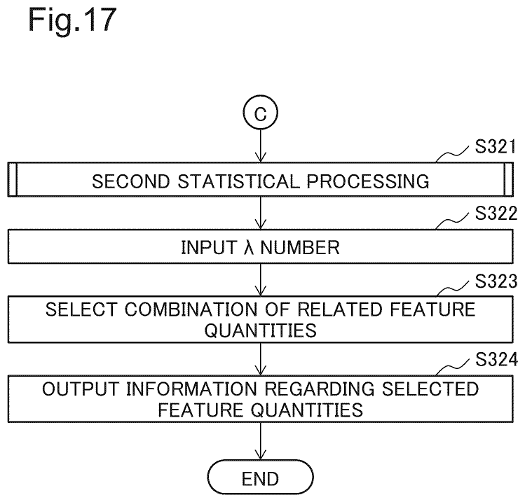

Next, operation of the feature quantity selection device 30 of the present example embodiment will be described with reference to the drawings. FIGS. 16 and 17 are flowcharts for describing an example of operation of the feature quantity selection device 30. In the description using the flowcharts of FIGS. 16 and 17, the feature quantity selection device 30 will be described as an operation subject.

In FIG. 16, first, the feature quantity selection device 30 acquires N data sets (step S311). The number of the data set corresponds to the number (feature quantity number) of the explanatory variable (feature quantity) included in the data set.

Next, the feature quantity selection device 30 sets the feature quantity number n to 1 (step S312). n is a number of a data set (feature quantity).

Next, the feature quantity selection device 30 excludes data of the n-th subject (step S313).

Next, the feature quantity selection device 30 performs Lasso regression for N−1 data sets from which the data of the n-th subject is excluded (step S314).

Next, the feature quantity selection device 30 increments (+1) the feature quantity number n (step S315).

Here, when the feature quantity number n is smaller than the number N of data sets (Yes in step S316), the process returns to step S313. On the other hand, when the feature quantity number n is equal to or more than the number N of data sets (No in step S316), the process proceeds to step S321 in FIG. 17.

When it is No in step S316 in FIG. 16, the feature quantity selection device 30 executes second statistical processing (step S321). As a first stage of the second statistical processing, the feature quantity selection device 30 generates the second matrix in which an average value of each cell is assigned to each cell of the first matrix of a plurality of patterns generated for each subject. As a second stage of the second statistical processing, the feature quantity selection device 30 sets a logical value (0, 1) for each cell with respect to the generated second matrix as the second statistical processing. For example, with respect to each cell of the second matrix, the feature quantity selection device 30 sets a cell in which the average value of the aggregated values is equal to or more than a predetermined threshold to TRUE (1). On the other hand, the feature quantity selection device 30 sets a cell in which the average value of the aggregated values is less than the predetermined threshold to FALSE (0).

Next, the feature quantity selection device 30 selects the A number based on the specifying rule in accordance with the result of the second statistical processing (step S322).

Next, the feature quantity selection device 30 selects a combination of feature quantities related to the selected A number (step S323).

Next, the feature quantity selection device 30 outputs information (selection information) regarding the selected feature quantity (step S324). The selection information output from the feature quantity selection device 30 is used as a condition for extracting a feature quantity from sensor data measured by a measuring device or the like.

As described above, the feature quantity selection device of the present example embodiment includes the acquisition unit, the construction unit, the analysis unit, the statistics unit, the selection unit, and the output unit. The acquisition unit acquires a plurality of data sets. The construction unit constructs a plurality of re-extracted data sets by changing the distribution of the data included in the data set. The analysis unit analyzes a plurality of re-extracted data sets using a Lasso regression method. The statistics unit aggregates values of elements included in the plurality of re-extracted data sets in accordance with the analysis results of the plurality of re-extracted data sets. The statistics unit sets logical values to elements included in the plurality of re-extracted data sets in accordance with the aggregation result of the values of the elements. The selection unit selects the feature quantity of the combination according to the value of the logical value set for the element in accordance with a preset specifying rule. The output unit outputs selection information on the selected combination of the feature quantities.

In the present example embodiment, the analysis unit executes Lasso regression for each of a plurality of preset regularization parameters for each of a plurality of re-extracted data sets. The analysis unit generates the first matrix of the plurality of patterns including a column related to the regularization parameter used in the Lasso regression and a row related to the feature quantity. The statistics unit aggregates the values of the elements for each cell constituting the first matrix of the plurality of patterns. The statistics unit executes the second statistical processing of generating the second matrix in which 1 is set as a second logical value to cells in which the average value of the values of the elements is equal to or more than a predetermined threshold, and 0 is set as a second logical value to cells in which the average value of the values of the elements is less than the predetermined threshold. The selection unit selects a column of the second matrix in accordance with a preset specifying rule, and selects a combination of feature quantities related to the selected column.

According to the present example embodiment, by performing Lasso regression by changing the distribution of data, it is possible to obtain a feature quantity having an average value closer to a true value as compared with a case where the influence of the jump value or the outlier is directly received. Thus, according to the present example embodiment, it is possible to select a feature quantity having high robustness against a jump value or an outlier.

### Fourth Example Embodiment

Next, a feature quantity selection device according to a fourth example embodiment will be described with reference to the drawings. The feature quantity selection device of the present example embodiment has a configuration in which the feature quantity selection devices of the first to third example embodiments are simplified.

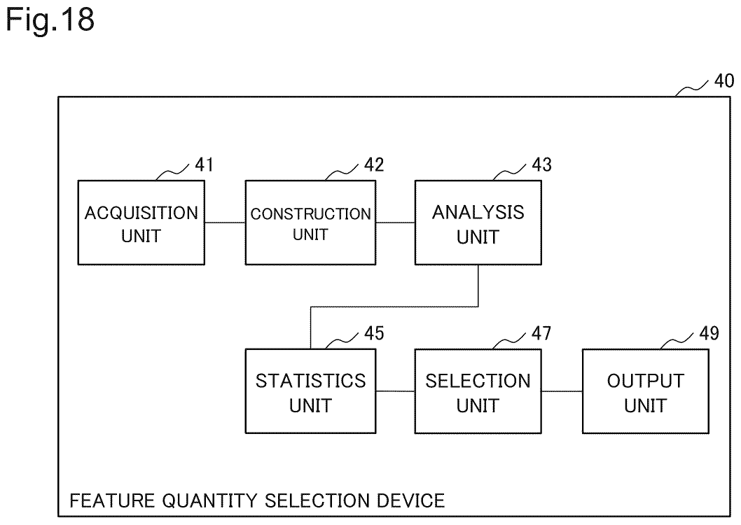

FIG. 18 is a block diagram illustrating an example of a configuration of the feature quantity selection device 40 according to the present example embodiment. The feature quantity selection device 40 includes an acquisition unit 41, a construction unit 42, an analysis unit 43, a statistics unit 45, a selection unit 47, and an output unit 49.

The acquisition unit 41 acquires a plurality of data sets. The construction unit 42 constructs a plurality of re-extracted data sets by changing the distribution of the data included in the data set. The analysis unit 43 analyzes a plurality of re-extracted data sets using a Lasso regression method. The statistics unit 45 aggregates values of elements included in the plurality of re-extracted data sets in accordance with the analysis results of the plurality of re-extracted data sets. The statistics unit 45 sets logical values to elements included in the plurality of re-extracted data sets in accordance with the aggregation result of the values of the elements. The selection unit 47 selects the feature quantity of the combination according to the value of the logical value set for the element in accordance with a preset specifying rule. The output unit 49 outputs selection information on the selected combination of the feature quantities.

According to the present example embodiment, by performing Lasso regression by changing the distribution of data, it is possible to obtain a feature quantity having an average value closer to a true value as compared with a case where the influence of the jump value or the outlier is directly received. Thus, according to the present example embodiment, it is possible to select a feature quantity having high robustness against a jump value or an outlier.

### Fifth Example Embodiment

Next, a machine learning system according to a fifth example embodiment will be described with reference to the drawings. The machine learning system of the present example embodiment executes machine learning using the feature quantity selected by the feature quantity selection devices of the first to fourth example embodiments.

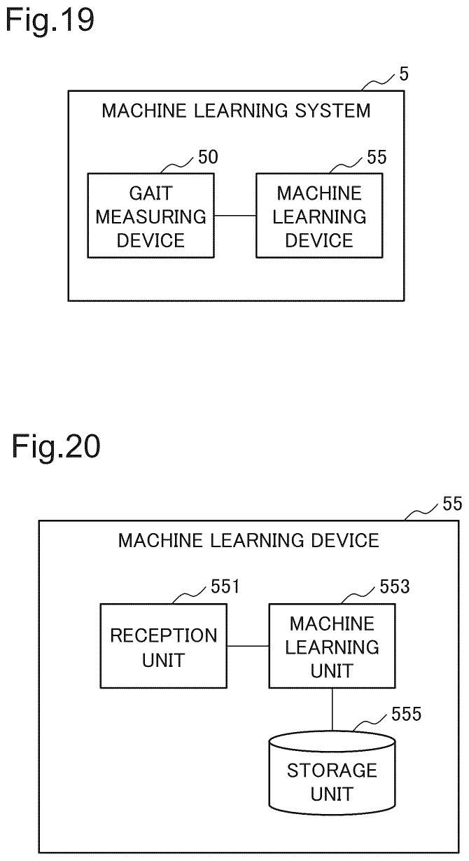

FIG. 19 is a block diagram illustrating an example of a configuration of the machine learning system 5 according to the present example embodiment. The machine learning system 5 includes a gait measuring device 50 and a machine learning device 55. The gait measuring device 50 and the machine learning device 55 may be connected by wire or wirelessly. The gait measuring device 50 and the machine learning device 55 may be configured by a single device. The machine learning system 5 may be configured only by the machine learning device 55 except for the gait measuring device 50 from the configuration of the machine learning system 5. Although only one gait measuring device 50 is illustrated in FIG. 19, one (two in total) gait measuring device 50 may be arranged on each of the left and right feet. The machine learning device 55 may be configured not to be connected to the gait measuring device 50 but to execute machine learning using the feature quantity data generated in advance by the gait measuring device 50 and stored in the database.

The gait measuring device 50 is installed on at least one of the left or right leg. The gait measuring device 50 has a configuration similar to that of the gait measuring device 50 of the first example embodiment. The gait measuring device 50 includes an acceleration sensor and an angular velocity sensor. The gait measuring device 50 converts the measured physical quantity into digital data (also referred to as sensor data). The gait measuring device 50 generates normalized gait waveform data for one gait cycle from the time-series data of the sensor data. The gait measuring device 50 generates feature quantity data used for estimating the body condition. The gait measuring device 50 transmits the generated feature quantity data to the machine learning device 55. The gait measuring device 50 may be configured to transmit the feature quantity data to a database (not illustrated) accessed by the machine learning device 55. The feature quantity data accumulated in the database is used for machine learning by the machine learning device 55.

The machine learning device 55 receives the feature quantity data from the gait measuring device 50. The feature quantity data received by the machine learning device 55 includes the feature quantities selected by the feature quantity selection devices of the first to fourth example embodiments. When using the feature quantity data accumulated in the database (not illustrated), the machine learning device 55 receives the feature quantity data from the database. The machine learning device 55 executes machine learning using the received feature quantity data. For example, the machine learning device 55 machine-learns teacher data in which feature quantity data extracted from a plurality of pieces of subject gait waveform data is set as an explanatory variable and a value related to the body condition according to the feature quantity data is set as an objective variable. The machine learning algorithm executed by the machine learning device 55 is not particularly limited. The machine learning device 55 generates an estimation model machine-learned using teacher data related to a plurality of subjects. The machine learning device 55 stores the generated estimation model. The estimation model machine-learned by the machine learning device 55 may be stored in a storage device outside the machine learning device 55.

### [Machine Learning Device]

Next, details of the machine learning device 55 will be described with reference to the drawings. FIG. 20 is a block diagram illustrating an example of a detailed configuration of the machine learning device 55. The machine learning device 55 includes a reception unit 551, a machine learning unit 553, and a storage unit 555.

The reception unit 551 receives the feature quantity data from the gait measuring device 50. The reception unit 551 outputs the received feature quantity data to the machine learning unit 553. The reception unit 551 may receive the feature quantity data from the gait measuring device 50 via a wire such as a cable, or may receive the feature quantity data from the gait measuring device 50 via wireless communication. For example, the reception unit 551 is configured to receive the feature quantity data from the gait measuring device 50 via a wireless communication function (not illustrated) conforming to a standard such as Bluetooth (registered trademark) or WiFi (registered trademark). The communication function of the reception unit 551 may conform to a standard other than Bluetooth (registered trademark) or WiFi (registered trademark).

The machine learning unit 553 acquires the feature quantity data from the reception unit 551. The machine learning unit 553 executes machine learning using the acquired feature quantity data. For example, the machine learning unit 553 machine-learns a data set in which the feature quantity data extracted regarding the gait of the subject is set as an explanatory variable and the body condition of the subject is set as an objective variable as teacher data. For example, the machine learning unit 553 sets the body condition such as the grip strength, the whole body muscle strength, the lower limb muscle strength, the mobility, the dynamic balance, or the static balance of the subject as a machine learning target. For example, the machine learning unit 553 generates an estimation model that estimates a body condition in response to input of feature quantity data machine-learned for a plurality of users. For example, the machine learning unit 553 generates an estimation model that performs estimation according to an attribute by using an explanatory variable including attribute data such as gender, age, height, and weight. The machine learning unit 553 stores estimation models machine-learned for a plurality of subjects in the storage unit 555.

For example, the machine learning unit 553 executes machine learning using a linear regression algorithm. For example, the machine learning unit 553 executes machine learning using an algorithm of a support vector machine (SVM). For example, the machine learning unit 553 executes machine learning using a Gaussian process regression (GPR) algorithm. For example, the machine learning unit 553 executes machine learning using a random forest (RF) algorithm. For example, the machine learning unit 553 may execute unsupervised machine learning of classifying a subject who is a generation source of the feature quantity data according to the feature quantity data. The machine learning algorithm executed by the machine learning unit 553 is not particularly limited.

The machine learning unit 553 may execute machine learning using the gait waveform data (sensor data) for one gait cycle as an explanatory variable. For example, the machine learning unit 553 executes supervised machine learning in which the accelerations in three axial directions, the angular velocity around the three axes, and the gait waveform data of the angle (posture angle) around the three axes are set as explanatory variables and the correct value of the body condition that is the estimation target is set as an objective variable.

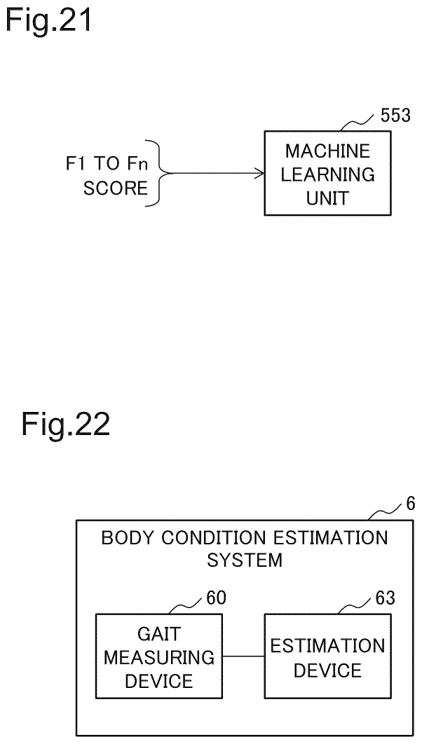

FIG. 21 is a conceptual diagram for describing machine learning for generating an estimation model. FIG. 21 is a conceptual diagram illustrating an example of causing the machine learning unit 553 to machine-learn a data set of feature quantities F1 to Fn as explanatory variables and a score regarding the body condition as an objective variable as teacher data. For example, the machine learning unit 553 machine-learns data regarding a plurality of subjects, and generates an estimation model that outputs an output (estimated value) regarding the body condition of the subject in response to input of a feature quantity extracted from the sensor data.

The storage unit 555 stores estimation models machine-learned for a plurality of subjects. For example, the storage unit 555 stores an estimation model that estimates a body condition machine-learned for a plurality of subjects. For example, the estimation model stored in the storage unit 555 is used for estimation of the body condition by the body condition estimation system of the sixth example embodiment described later.

As described above, the machine learning system of the present example embodiment includes the gait measuring device and the machine learning device. The gait measuring device acquires time-series data of sensor data regarding movement of the foot. The gait measuring device extracts gait waveform data for one gait cycle from the time-series data of the sensor data, and normalizes the extracted gait waveform data. The gait measuring device extracts a feature quantity regarding the body condition of the estimation target from the normalized gait waveform data. The gait measuring device extracts feature quantities selected by the feature quantity selection devices of the first to fourth example embodiments. The gait measuring device generates feature quantity data including the extracted feature quantity. The gait measuring device outputs the generated feature quantity data to the machine learning device.

The machine learning device includes a reception unit, a machine learning unit, and a storage unit. The reception unit acquires the feature quantity data generated by the gait measuring device. The machine learning unit executes machine learning using the feature quantity data. The machine learning unit generates an estimation model that outputs the body condition in response to input of a feature quantity extracted from time-series data of sensor data measured with the gait of the user. The estimation model generated by the machine learning unit is stored in the storage unit.

The machine learning system of the present example embodiment generates an estimation model by using the feature quantity data measured by the gait measuring device. The machine learning system of the present example embodiment executes machine learning using the feature quantity selected by the feature quantity selection devices of the first to fourth example embodiments. Thus, according to the present aspect, it is possible to generate an estimation model capable of appropriately estimating the body condition in daily life using a feature quantity with high robustness.

### Sixth Example Embodiment

Next, a body condition estimation system according to a sixth example embodiment will be described with reference to the drawings. The body condition estimation system of the present example embodiment measures sensor data regarding the movement of the foot according to the gait of the user. The body condition estimation system of the present example embodiment estimates the body condition of the user by using the measured sensor data. For example, the body condition estimation system of the present example embodiment estimates, as the body condition, a muscle strength index such as a grip strength and a knee extension strength, a dynamic balance, a lower limb muscle strength, a mobility, a static balance, and the like. The sensor data may be sensor data including features related to gait measured using motion capture, smart apparel, or the like.

### (Configuration)

FIG. 22 is a block diagram illustrating an example of a configuration of the body condition estimation system 6 according to the present example embodiment. The body condition estimation system 6 includes a gait measuring device 60 and an estimation device 63. In the present example embodiment, an example in which the gait measuring device 60 and the estimation device 63 are configured as separate hardware will be described. For example, the gait measuring device 60 is installed on footwear or the like of the subject (user) who is the body condition estimation target. For example, the function of the estimation device 63 is installed in a mobile terminal carried by a subject (user). Hereinafter, configurations of the gait measuring device 60 and the estimation device 63 will be individually described.

### [Gait Measuring Device]

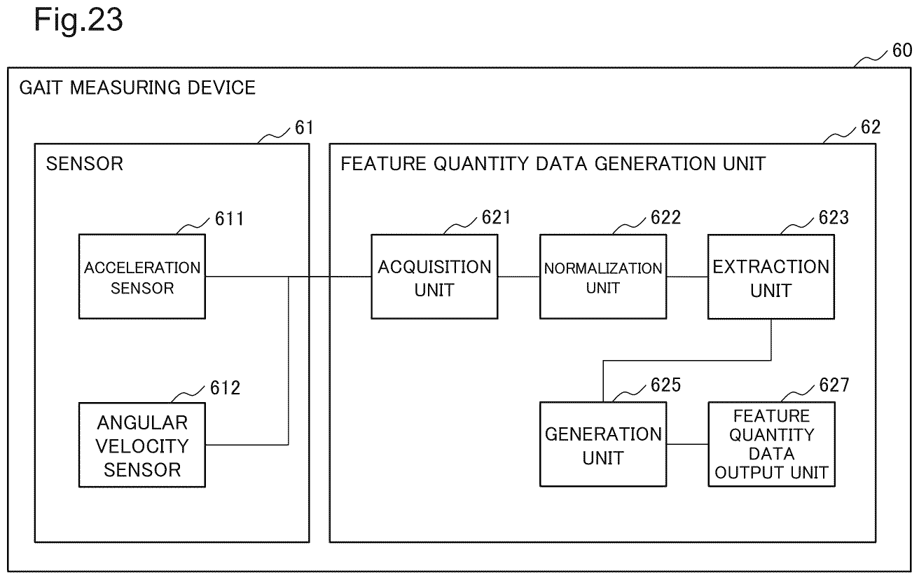

FIG. 23 is a block diagram illustrating an example of a configuration of the gait measuring device 60. The gait measuring device 60 includes a sensor 61 and a feature quantity data generation unit 62. In the present example embodiment, an example in which the sensor 61 and the feature quantity data generation unit 62 are integrated will be described. The sensor 61 and the feature quantity data generation unit 62 may be provided as separate devices.

As illustrated in FIG. 23, the sensor 61 includes an acceleration sensor 611 and an angular velocity sensor 612. FIG. 23 illustrates an example in which the acceleration sensor 611 and the angular velocity sensor 612 are included in the sensor 61. The sensor 61 may include a sensor other than the acceleration sensor 611 and the angular velocity sensor 612. Sensors other than the acceleration sensor 611 and the angular velocity sensor 612 that can be included in the sensor 61 will not be described.

The acceleration sensor 611 is a sensor that measures accelerations (also referred to as spatial accelerations) in three axial directions. The acceleration sensor 611 measures an acceleration (also referred to as spatial acceleration) as a physical quantity related to movement of the foot. The acceleration sensor 611 outputs measured acceleration to the feature quantity data generation unit 62. For example, a sensor of a piezoelectric type, a piezoresistive type, a capacitance type, or the like can be used as the acceleration sensor 611. The sensor used as the acceleration sensor 611 is not limited to the measurement method as long as the sensor can measure acceleration.

The angular velocity sensor 612 is a sensor that measures an angular velocity (also referred to as a spatial angular velocity) around three axes. The angular velocity sensor 612 measures the angular velocity (also referred to as spatial angular velocity) as a physical quantity related to movement of the foot. The angular velocity sensor 612 outputs the measured angular velocity to the feature quantity data generation unit 62. For example, a sensor of a vibration type, a capacitance type, or the like can be used as the angular velocity sensor 612. The sensor used as the angular velocity sensor 612 is not limited to the measurement method as long as the sensor can measure the angular velocity.

The sensor 61 is implemented by, for example, an inertial measuring device that measures acceleration and angular velocity. An example of the inertial measuring device is an inertial measurement unit (IMU). The IMU includes the acceleration sensor 611 that measures accelerations in three axial directions and the angular velocity sensor 612 that measures angular velocities around the three axes. The sensor 61 may be implemented by an inertial measuring device such as a vertical gyro (VG) or an attitude heading (AHRS). The sensor 61 may be implemented by global positioning system/inertial navigation system (GPS/INS). The sensor 61 may be implemented by a device other than the inertial measuring device as long as it can measure a physical quantity related to movement of the foot.

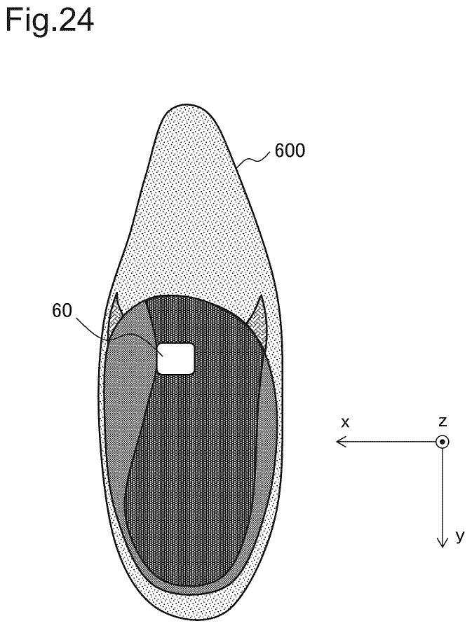

FIG. 24 is a conceptual diagram illustrating an example in which the gait measuring device 60 is arranged in a shoe 600 of the right foot. In the example of FIG. 24, the gait measuring device 60 is installed at a position corresponding to the back side of the arch of foot. For example, the gait measuring device 60 is arranged in an insole inserted into the shoe 600. For example, the gait measuring device 60 may be arranged on the bottom surface of the shoe 600. For example, the gait measuring device 60 may be embedded in the main body of the shoe 600. The gait measuring device 60 may be detachable from the shoe 600 or may not be detachable from the shoe 600. The gait measuring device 60 may be installed at a position other than a back side of the arch of foot as long as sensor data regarding the movement of the foot can be measured. The gait measuring device 60 may be installed on a sock worn by the user or a decorative article such as an anklet worn by the user. The gait measuring device 60 may be directly attached to the foot or may be embedded in the foot. FIG. 24 illustrates an example in which the gait measuring device 60 is installed in the shoe 600 of the right foot. The gait measuring device 60 may be installed on the shoes 600 of both feet.

In the example of FIG. 24, a local coordinate system including an x axis in the left-right direction, a y axis in the front-back direction, and a z axis in the up-down direction is set with reference to the gait measuring device 60 (sensor 61). In the x-axis, the left side is positive, in the y-axis, the rear side is positive, and in the z-axis, the upper side is positive. The direction of the axis set in the sensor 61 may be the same for the left and right feet, or may be different for the left and right feet. For example, in a case where the sensors 61 produced with the same specifications are arranged in the left and right shoes 600, the vertical directions (directions in the Z-axis direction) of the sensors 61 arranged in the left and right shoes 600 are the same. In this case, the three axes of the local coordinate system set in sensor data derived from the left foot and the three axes of the local coordinate system set in sensor data derived from the right foot are the same on the left and right.

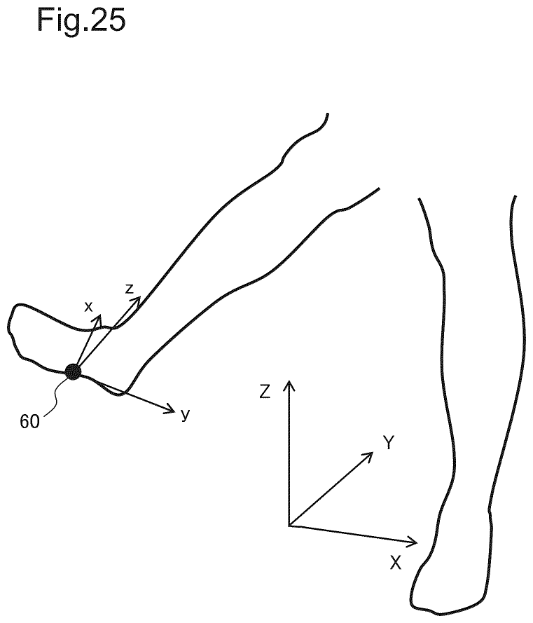

FIG. 25 is a conceptual diagram for describing a local coordinate system (x-axis, y-axis, z-axis) set in the gait measuring device 60 (sensor 61) installed on the back side of the arch of foot and a world coordinate system (X axis, Y axis, Z axis) set with respect to the ground. In the world coordinate system (X axis, Y axis, Z axis), in a state where the user facing a traveling direction is upright, a lateral direction of the user is set to the X-axis direction (a leftward direction is positive), a direction of the back surface of the user is set to the Y-axis direction (a rearward direction is positive), and a gravity direction is set to the Z-axis direction (a vertically upward direction is positive). The example of FIG. 25 conceptually illustrates the relationship between the local coordinate system (x-axis, y-axis, z-axis) and the world coordinate system (X axis, Y axis, Z axis), and does not accurately illustrate the relationship between the local coordinate system and the world coordinate system that varies depending on the gait of the user.

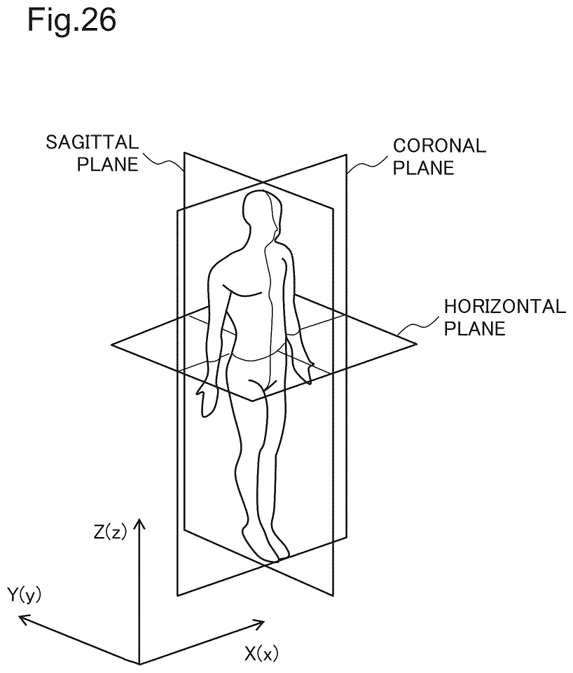

FIG. 26 is a conceptual diagram for describing a surface (also referred to as a human body surface) set for the human body. In the present example embodiment, a sagittal plane dividing the body into left and right, a coronal plane dividing the body into front and rear, and a horizontal plane dividing the body horizontally are defined. As illustrated in FIG. 26, the world coordinate system and the local coordinate system coincide with each other in a state in which a center line of the foot is oriented in the traveling direction. In the present example embodiment, rotation in the sagittal plane with the x-axis as the rotation axis is defined as roll, rotation in the coronal plane with the y-axis as the rotation axis is defined as pitch, and rotation in the horizontal plane with the z-axis as the rotation axis is defined as yaw. A rotation angle in the sagittal plane with the x axis as a rotation axis is defined as a roll angle, a rotation angle in the coronal plane with the y axis as a rotation axis is defined as a pitch angle, and a rotation angle in the horizontal plane with the z axis as a rotation axis is defined as a yaw angle.

As illustrated in FIG. 23, the feature quantity data generation unit 62 (also referred to as a feature quantity data generation device) includes an acquisition unit 621, a normalization unit 622, an extraction unit 623, a generation unit 625, and a feature quantity data output unit 627. For example, the feature quantity data generation unit 62 is implemented by a microcomputer or a microcontroller that performs overall control and data processing of the gait measuring device 60. For example, the feature quantity data generation unit 62 includes a central processing unit (CPU), a random access memory (RAM), a read only memory (ROM), a flash memory, and the like. The feature quantity data generation unit 62 controls the acceleration sensor 611 and the angular velocity sensor 612 to measure the angular velocity and the acceleration. For example, the feature quantity data generation unit 62 may be implemented on a mobile terminal (not illustrated) carried by a subject (user).

The acquisition unit 621 acquires accelerations in three axial directions from the acceleration sensor 611. The acquisition unit 621 acquires angular velocities around three axes from the angular velocity sensor 612. For example, the acquisition unit 621 performs analog-to-digital conversion (AD conversion) on acquired physical quantities (analog data) such as angular velocity and acceleration. The physical quantities (analog data) measured by the acceleration sensor 611 and the angular velocity sensor 612 may be converted into digital data in each of the acceleration sensor 611 and the angular velocity sensor 612. The acquisition unit 621 outputs the converted digital data (also referred to as sensor data) to the normalization unit 622. The acquisition unit 621 may be configured to store the sensor data in a storage unit (not illustrated). The sensor data includes at least acceleration data converted into digital data and angular velocity data converted into digital data. The acceleration data includes acceleration vectors in three axial directions. The angular velocity data includes angular velocity vectors around three axes. The acceleration data and the angular velocity data are associated with acquisition times of the data. The acquisition unit 621 may add a correction such as a mounting error, a temperature correction, or a linearity correction to the acceleration data and the angular velocity data.

The normalization unit 622 acquires sensor data from the acquisition unit 621. The normalization unit 622 extracts time-series data (also referred to as gait waveform data) for one gait cycle from the time-series data of the accelerations in the three axial directions and the angular velocities around the three axes included in the sensor data. The normalization unit 622 normalizes (also referred to as first normalization) time of the extracted gait waveform data for one gait cycle to a gait cycle of 0 to 100% (percent). Timing such as 1% or 10% included in the gait cycle of 0 to 100% is also referred to as a gait phase. The normalization unit 622 normalizes (also referred to as second normalization) gait waveform data for one gait cycle having subjected to the first normalization in such a way that a stance phase is 60% and a swing phase is 40%. The stance phase is a period in which at least a part of the back side of the foot is in contact with the ground. The swing phase is a period in which the back side of the foot is away from the ground. When the gait waveform data is subjected to the second normalization, it is possible to suppress deviation of the gait phase from which a feature quantity is extracted from fluctuating due to the influence of disturbance.

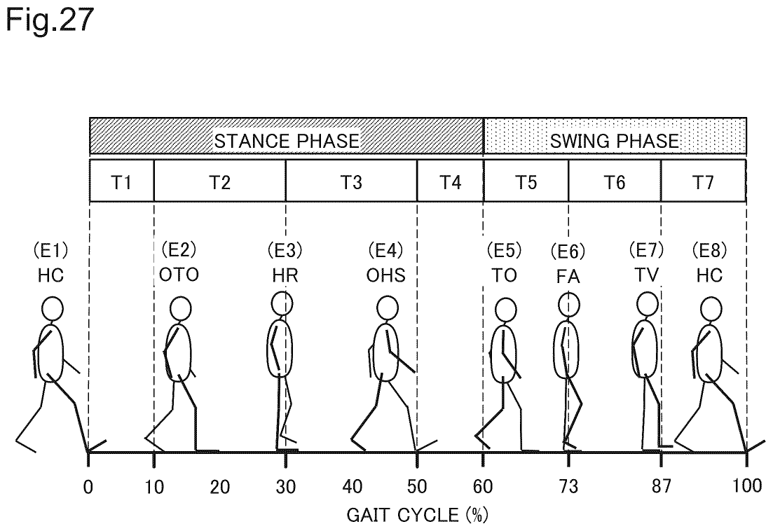

FIG. 27 is a conceptual diagram for describing one gait cycle with the right foot as a reference. One gait cycle based on the left foot is also similar to that of the right foot. The horizontal axis of FIG. 27 is one gait cycle of the right foot with a time point at which the heel of the right foot lands on the ground as a starting point and a time point at which the heel of the right foot next lands on the ground as an ending point. The horizontal axis in FIG. 27 has been subjected to the first normalization with one gait cycle as 100%. In the horizontal axis of FIG. 27, the second normalization is performed in such a way that the stance phase is 60% and the swing phase is 40%. One gait cycle of one foot is roughly divided into a stance phase in which at least a part of the back side of the foot is in contact with the ground and a swing phase in which the back side of the foot is away from the ground. The stance phase is further subdivided into a load response period T1, a mid-stance period T2, a terminal stance period T3, and a pre-swing period T4. The swing phase is subdivided into an initial swing period T5, a mid-swing period T6, and a terminal swing period T7. FIG. 27 is an example, and does not limit the periods constituting one gait cycle, the names of these periods, and the like.

As illustrated in FIG. 27, in a gait, multiple events (also referred to as gait events) occur. E1 represents an event in which the heel of the right foot touches the ground (heel contact (HC)). E2 represents an event in which the toe of the left foot is separated from the ground with the sole of the right foot in contact with the ground (opposite toe off (OTO)). E3 represents an event in which the heel of the right foot rises with the sole of the right foot in contact with the ground (heel rise (HR)). E4 is an event in which the heel of the left foot touches the ground (opposite heel strike (OHS)). E5 represents an event in which the toe of the right foot is separated from the ground with the sole of the left foot in contact with the ground (toe off (TO)). E6 represents an event in which the left foot and the right foot cross with the sole of the left foot in contact with the ground (foot adjacent (FA)). E7 represents an event in which the tibia of the right foot is approximately perpendicular to the ground with the sole of the left foot in contact with the ground (tibia vertical (TV)). E8 represents an event in which the heel of the right foot touches the ground (heel contact (HC)). E8 corresponds to the end point of the gait cycle starting from E1 and corresponds to the start point of the next gait cycle. FIG. 27 is an example, and does not limit events that occur during a gait or names of these events.

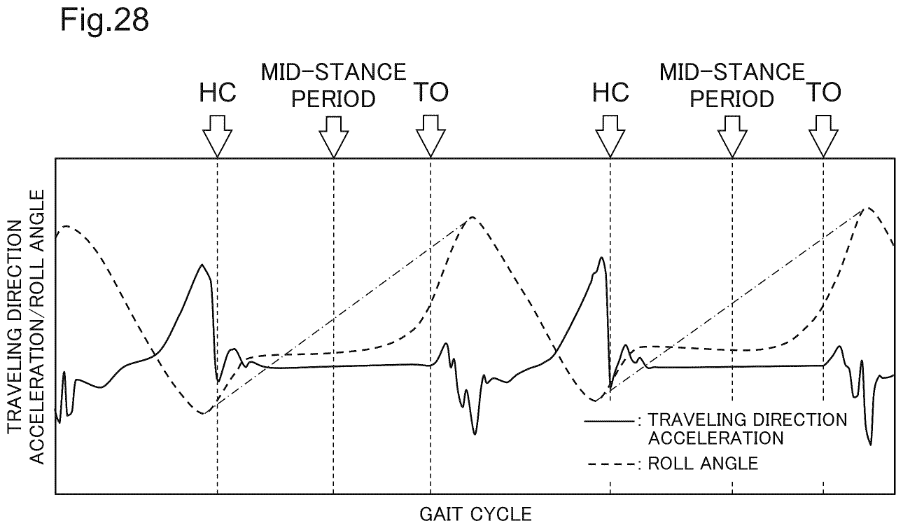

FIG. 28 is a diagram for describing an example of detecting the heel contact HC and the toe off TO from time-series data (solid line) of a traveling direction acceleration (Y-direction acceleration). The timing of the heel contact HC is a timing of a minimum peak immediately after a maximum peak appearing in the time-series data of the traveling direction acceleration (Y-direction acceleration). A maximum peak serving as a mark of the timing of the heel contact HC corresponds to the largest peak of gait waveform data for one gait cycle. A section between consecutive heel contacts HC is one gait cycle. The timing of the toe off TO is a rising timing of a maximum peak appearing after the period of the stance phase in which fluctuation does not appear in the time-series data of the traveling direction acceleration (Y-direction acceleration). FIG. 28 also illustrates time-series data (broken line) of a roll angle (angular velocity around the X axis). A timing at a midpoint between a timing at which the roll angle is minimum and a timing at which the roll angle is maximum corresponds to the mid-stance period. For example, parameters such as gait speed, stride, circumduction, medial/lateral rotation, and plantarflexion/dorsiflexion (also referred to as gait parameters) can be obtained with reference to the mid-stance period.

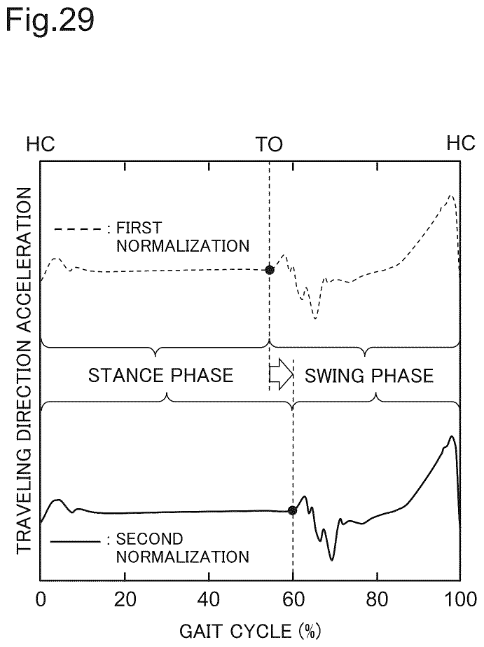

FIG. 29 is a diagram for describing an example of the gait waveform data normalized by the normalization unit 622. The normalization unit 622 detects the heel contact HC and the toe off TO from the time-series data of the traveling direction acceleration (Y-direction acceleration). The normalization unit 622 extracts a section between consecutive heel contacts HC as gait waveform data for one gait cycle. The normalization unit 622 converts the horizontal axis (time axis) of the gait waveform data for one gait cycle into a gait cycle of 0 to 100% by the first normalization. In FIG. 29, the gait waveform data after the first normalization is indicated by a broken line. In the gait waveform data (broken line) after the first normalization, the timing of the toe off TO deviates from 60%.

In the example of FIG. 29, the normalization unit 622 normalizes a section from the heel contact HC at which the gait phase is 0% to the toe off TO subsequent to the heel contact HC to 0 to 60%. The normalization unit 622 normalizes a section from the toe off TO to the heel contact HC at which the gait phase subsequent to the toe off TO is 100% to 60 to 100%. As a result, the gait waveform data for one gait cycle is normalized to a section (stance phase) in which the gait cycle is 0 to 60% and a section (swing phase) in which the gait cycle is 60 to 100%. In FIG. 8, the gait waveform data after the second normalization is indicated by a solid line. In the gait waveform data (solid line) after the second normalization, the timing of the toe off TO coincides with 60%.

FIGS. 28 to 29 illustrate examples in which the gait waveform data for one gait cycle is extracted/normalized based on the traveling direction acceleration (Y-direction acceleration). With respect to acceleration/angular velocity other than the traveling direction acceleration (Y-direction acceleration), the normalization unit 622 extracts/normalizes gait waveform data for one gait cycle in accordance with the gait cycle of the traveling direction acceleration (Y-direction acceleration). The normalization unit 622 may generate time-series data of angles around three axes by integrating time-series data of angular velocities around the three axes. In this case, the normalization unit 622 also extracts/normalizes the gait waveform data for one gait cycle in accordance with the gait cycle of the traveling direction acceleration (Y-direction acceleration) with respect to the angle around the three axes.

The normalization unit 622 may extract/normalize the gait waveform data for one gait cycle based on acceleration/angular velocity other than the traveling direction acceleration (Y-direction acceleration) (drawings are omitted). For example, the normalization unit 622 may detect the heel contact HC and the toe off TO from time-series data of vertical acceleration (Z-direction acceleration). The timing of the heel contact HC is a timing of a steep minimum peak appearing in the time-series data of the vertical acceleration (Z-direction acceleration). At the timing of the steep minimum peak, the value of the vertical acceleration (Z-direction acceleration) becomes substantially zero. The minimum peak serving as a mark of the timing of the heel contact HC corresponds to the smallest peak of the gait waveform data for one gait cycle. A section between consecutive heel contacts HC is one gait cycle. The timing of the toe off TO is a timing of an inflection point in the middle of gradually increasing after the time-series data of the vertical acceleration (Z-direction acceleration) passes through a section with a small fluctuation after the maximum peak immediately after the heel contact HC. The normalization unit 622 may extract/normalize the gait waveform data for one gait cycle based on both the traveling direction acceleration (Y-direction acceleration) and the vertical acceleration (Z-direction acceleration). The normalization unit 622 may extract/normalize the gait waveform data for one gait cycle based on acceleration, angular velocity, angle, and the like other than the traveling direction acceleration (Y-direction acceleration) and the vertical acceleration (Z-direction acceleration).

The extraction unit 623 acquires the gait waveform data for one gait cycle normalized by the normalization unit 622. The extraction unit 623 extracts a feature quantity used for estimating the body condition from the gait waveform data for one gait cycle. The extraction unit 623 extracts a feature quantity for each gait phase cluster from a gait phase cluster obtained by integrating temporally continuous gait phases based on a preset condition. The gait phase cluster includes at least one gait phase. The gait phase cluster also includes a single gait phase. The gait waveform data and the gait phase from which the feature quantity used for estimating the body condition is extracted will be described later.

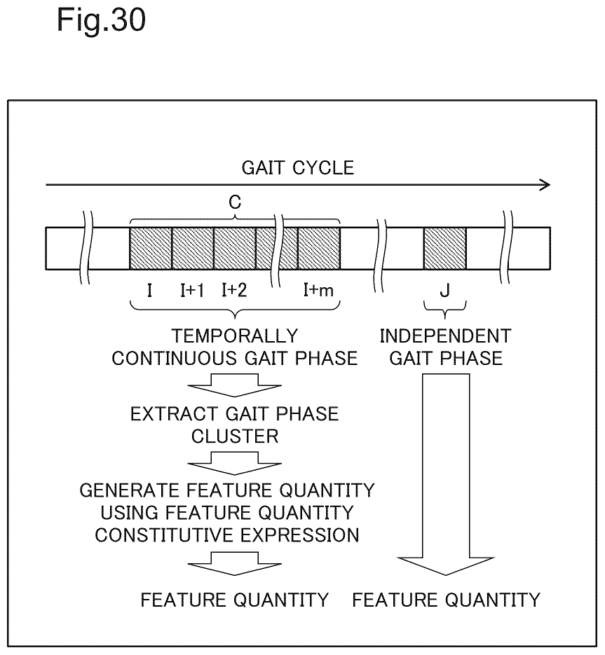

FIG. 30 is a conceptual diagram for describing extraction of a feature quantity for estimating the body condition from gait waveform data for one gait cycle. For example, the extraction unit 623 extracts temporally continuous gait phases I to I+m as the gait phase cluster C (I and m are natural numbers). The gait phase cluster C includes m gait phases (components). That is, the number of gait phases (components) (also referred to as the number of components) constituting the gait phase cluster C is m. FIG. 30 illustrates an example in which the gait phase has an integer value, but the gait phase may be subdivided into decimal places. When the gait phase is subdivided into decimal places, the number of components of the gait phase cluster C is a number corresponding to the number of data points in the section of the gait phase cluster. The extraction unit 623 extracts a feature quantity from each of the gait phases I to I+m. In a case where the gait phase cluster C includes a single gait phase J, the extraction unit 623 extracts a feature quantity from the single gait phase J (J is a natural number).

The generation unit 625 applies a feature quantity constitutive expression to the feature quantity (first feature quantity) extracted from each of the gait phases constituting the gait phase cluster to generate a feature quantity (second feature quantity) of the gait phase cluster. The feature quantity constitutive expression is a preset calculation expression for generating a feature quantity of a gait phase cluster. For example, the feature quantity constitutive expression is a calculation expression related to four arithmetic operations. For example, the second feature quantity calculated using the feature quantity constitutive expression is an integral average value, an arithmetic average value, an inclination, a variation, or the like of the first feature quantity in each gait phase included in the gait phase cluster. For example, the generation unit 625 applies a calculation expression for calculating the inclination or variation of the first feature quantity extracted from each of the gait phases constituting the gait phase cluster as the feature quantity constitutive expression. For example, in a case where the gait phase cluster is configured by an independent gait phase, it is not possible to calculate the inclination or variation, and thus it is sufficient to use a feature quantity constitutive expression for calculating an integral average value, an arithmetic average value, or the like.

The feature quantity data output unit 627 outputs the feature quantity data for each gait phase cluster generated by the generation unit 625. The feature quantity data output unit 627 outputs the generated feature quantity data of the gait phase cluster to the estimation device 63 that uses the feature quantity data.

### [Estimation Device]

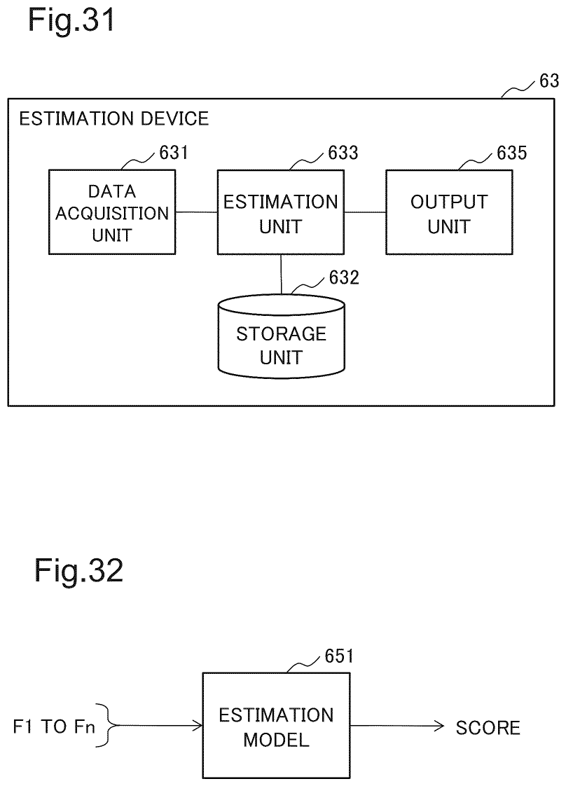

FIG. 31 is a block diagram illustrating an example of a configuration of the estimation device 63. The estimation device 63 includes a data acquisition unit 631, a storage unit 632, an estimation unit 633, and an output unit 635.

The data acquisition unit 631 acquires feature quantity data from the gait measuring device 60. The data acquisition unit 631 outputs the received feature quantity data to the estimation unit 633. The data acquisition unit 631 may receive the feature quantity data from the gait measuring device 60 via a wire such as a cable, or may receive the feature quantity data from the gait measuring device 60 via wireless communication. For example, the data acquisition unit 631 is configured to receive the feature quantity data from the gait measuring device 60 via a wireless communication function (not illustrated) conforming to a standard such as Bluetooth (registered trademark) or WiFi (registered trademark). The communication function of the data acquisition unit 631 may conform to a standard other than Bluetooth (registered trademark) or WiFi (registered trademark).

The storage unit 632 stores an estimation model that estimates the body condition using the feature quantity data extracted from the gait waveform data. The storage unit 632 stores the feature quantity data regarding the body conditions of the plurality of subjects and the estimation model that has machine-learned the relationship with the body conditions. For example, the storage unit 632 stores an estimation model that estimates a body condition machine-learned for a plurality of subjects. For example, the storage unit 632 may store an estimation model according to an attribute.

The estimation model only needs to be stored in the storage unit 632 at the time of factory shipment of a product, calibration before the user uses the body condition estimation system 6, or the like. For example, an estimation model stored in a storage device such as an external server may be used. In that case, the estimation model only needs to be configured to be used via an interface (not illustrated) connected to the storage device.

The estimation unit 633 acquires the feature quantity data from the data acquisition unit 631. The estimation unit 633 estimates the body condition using the acquired feature quantity data. The estimation unit 633 inputs the feature quantity data to the estimation model stored in the storage unit 632. The estimation unit 633 outputs an estimation result according to the body condition output from the estimation model. In a case where an estimation model stored in an external storage device constructed in a cloud, a server, or the like is used, the estimation unit 633 is configured to use the estimation model via an interface (not illustrated) connected to the storage device.

The output unit 635 outputs the estimation result of the body condition by the estimation unit 633. For example, the output unit 635 displays the estimation result of the body condition on the screen of the mobile terminal of the subject (user). For example, the output unit 635 outputs the estimation result to an external system or the like that uses the estimation result. The use of the body condition output from the estimation device 63 is not particularly limited.

For example, the estimation device 63 is connected to an external system or the like constructed in a cloud or a server via a mobile terminal (not illustrated) carried by a subject (user). The mobile terminal (not illustrated) is a portable communication device. For example, the mobile terminal is a portable communication device having a communication function, such as a smartphone, a smart watch, or a mobile phone. For example, the estimation device 63 is connected to the mobile terminal via a wire such as a cable. For example, the estimation device 63 is connected to the mobile terminal via wireless communication. For example, the estimation device 63 is connected to the mobile terminal via a wireless communication function (not illustrated) conforming to a standard such as Bluetooth (registered trademark) or WiFi (registered trademark). The communication function of the estimation device 63 may conform to a standard other than Bluetooth (registered trademark) or WiFi (registered trademark). The estimation result of the body condition may be used by an application installed on the mobile terminal. In that case, the mobile terminal executes processing using the estimation result by application software or the like installed in the mobile terminal.

FIG. 32 is a conceptual diagram illustrating an example in which the feature quantities F1 to Fn extracted from the sensor data measured along with a gait of the user are input to an estimation model 651 constructed in advance for estimating a body condition by the machine learning system of the fifth example embodiment, and a score regarding the body condition is output. The estimation model 651 outputs the score of the body condition in response to the input of the feature quantities F1 to Fn. For example, the estimation model 651 is generated by machine learning using teacher data in which the feature quantities F1 to Fn used for estimating the body condition are explanatory variables and the body condition is an objective variable. As long as the estimation result regarding the body condition is output in response to input of the feature quantity data for estimating the body condition, the estimation result of the estimation model 651 is not limited. For example, the estimation model 651 may be a model that estimates the body condition using attributes such as gender, age, height, and weight as explanatory variables in addition to the feature quantities F1 to Fn used for estimating the body condition.

For example, the storage unit 632 stores an estimation model that estimates a body condition using a multiple regression prediction method. For example, the storage unit 632 stores a parameter for estimating the score S of the body condition using the following Expression 1.

$$S = f 1 \times F 1 + f 2 \times F 2 + … + fn \times Fn + f 0 \qquad ( 1 )$$

In Expression 1 above, F1, F2, . . . , and Fn are feature quantities for each gait phase cluster used for estimation of the body condition. f1, f2, . . . , fn are coefficients multiplied by F1, F2, . . . , Fn. f0 is a constant term. For example, coefficients such as f1, f2, . . . , and fn are stored in the storage unit 632.

### (Operation)

Next, operation of the body condition estimation system 6 will be described with reference to the drawings. Here, the gait measuring device 60 and the estimation device 63 included in the body condition estimation system 6 will be individually described. With respect to the gait measuring device 60, operation of the feature quantity data generation unit 62 included in the gait measuring device 60 will be described.

### [Gait Measuring Device]

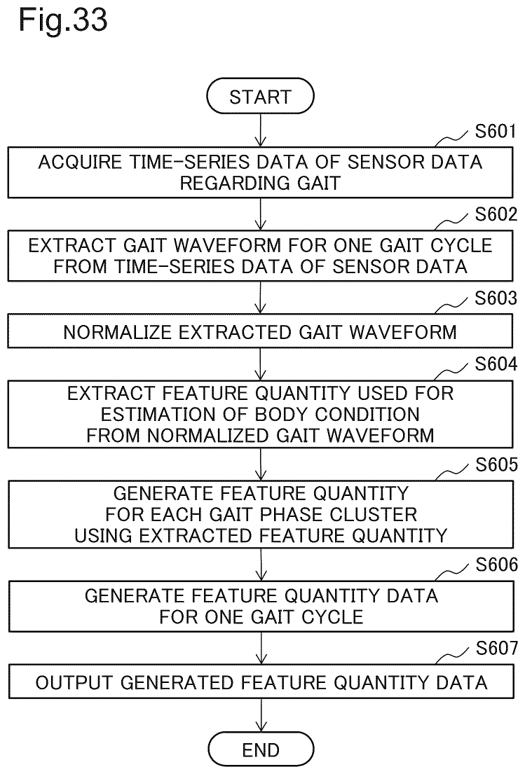

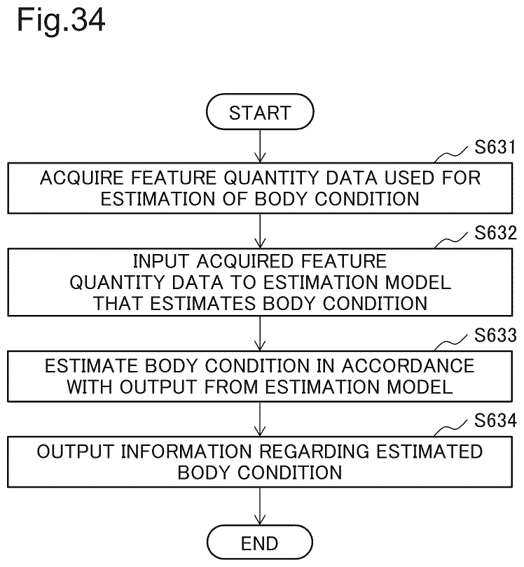

FIG. 33 is a flowchart for describing operation of the feature quantity data generation unit 62 included in the gait measuring device 60. In the description along the flowchart of FIG. 33, the feature quantity data generation unit 62 will be described as an operation subject.

In FIG. 33, first, the feature quantity data generation unit 62 acquires time-series data of sensor data regarding a gait (step S601).

Next, the feature quantity data generation unit 62 extracts gait waveform data for one gait cycle from the time-series data of the sensor data (step S602). The feature quantity data generation unit 62 detects a heel contact and a toe off from the time-series data of the sensor data. The feature quantity data generation unit 62 extracts time-series data of a section between consecutive heel contacts as gait waveform data for one gait cycle.

Next, the feature quantity data generation unit 62 normalizes the extracted gait waveform data for one gait cycle (step S603). The feature quantity data generation unit 62 normalizes the gait waveform data for one gait cycle to a gait cycle of 0 to 100% (first normalization). Further, the feature quantity data generation unit 62 normalizes the ratio of a stance phase to a swing phase in the gait waveform data for one gait cycle having subjected to the first normalization to 60:40 (second normalization).

Next, the feature quantity data generation unit 62 extracts a feature quantity from the gait phase used for estimating the body condition with respect to the normalized gait waveform (step S604). For example, the feature quantity data generation unit 62 extracts a feature quantity input to an estimation model constructed for each gender.

Next, the feature quantity data generation unit 62 generates feature quantities for each gait phase cluster using the extracted feature quantity (step S605).

Next, the feature quantity data generation unit 62 integrates the feature quantities for each gait phase cluster to generate feature quantity data for one gait cycle (step S606).

Next, the feature quantity data generation unit 62 outputs the generated feature quantity data to the estimation device 63 (step S607).

### [Estimation Device]

FIG. 33 is a flowchart for describing operation of the estimation device 63. In the description along the flowchart of FIG. 33, the estimation device 63 will be described as an operation subject.

In FIG. 33, first, the estimation device 63 acquires feature quantity data generated using sensor data regarding a gait (step S631).

Next, the estimation device 63 inputs the acquired feature quantity data to an estimation model that estimates a body condition (step S632).

Next, the estimation device 63 estimates the body condition of the user in accordance with the output (estimated value) from the estimation model (step S633).

Next, the estimation device 63 outputs information regarding the estimated body condition (step S634). For example, the body condition is output to a terminal device (not illustrated) carried by the user. For example, the body condition is output to a system that executes processing using the body condition.

### Application Example

Next, an application example according to the present example embodiment will be described with reference to the drawings. In the following application example, an example in which the function of the estimation device 63 installed in the mobile terminal carried by the user estimates the body condition using the feature quantity data measured by the gait measuring device 60 arranged in the shoe will be described.

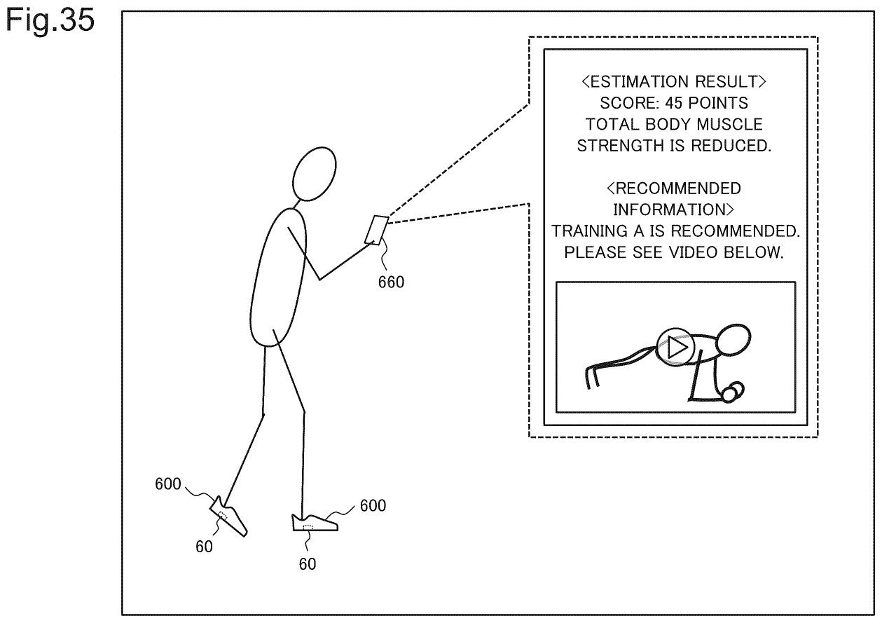

FIG. 35 is a conceptual diagram illustrating an example in which an estimation result by the estimation device 63 is displayed on the screen of a mobile terminal 660 carried by the user walking while wearing the shoes 600 on which the gait measuring device 60 is arranged. FIG. 35 is an example in which information corresponding to an estimation result of the body condition using the feature quantity data corresponding to sensor data measured while the user is walking is displayed on the screen of the mobile terminal 660.

FIG. 35 is an example in which information according to the estimated value regarding the body condition is displayed on the screen of the mobile terminal 660. In the example of FIG. 35, a score quantified based on a preset criterion is displayed on the display unit of the mobile terminal 660 as the estimation result regarding the body condition. In the example of FIG. 35, information regarding the estimation result of the body condition of “Total body muscle strength is reduced.” is displayed on the display unit of the mobile terminal 660 in accordance with the estimated value regarding the body condition. In the example of FIG. 35, recommendation information based on the estimation result of the total body muscle strength of “Training A is recommended. Please see the video below.” is displayed on the display unit of the mobile terminal 660 in accordance with the estimated value of the body condition. The user who has confirmed the information displayed on the display unit of the mobile terminal 660 can practice training leading to improvement of the total body muscle strength by exercising with reference to the video of the training A in accordance with the displayed recommendation information.

As described above, the body condition estimation system of the present example embodiment includes the gait measuring device and the body condition estimation device. The gait measuring device includes a sensor and a feature quantity data generation unit. The sensor includes an acceleration sensor and an angular velocity sensor. The sensor measures a spatial acceleration using an acceleration sensor. The sensor measures a spatial angular velocity using an angular velocity sensor. The sensor uses the measured spatial acceleration and spatial angular velocity to generate sensor data regarding movement of the foot. The sensor outputs the generated sensor data to the feature quantity data generation unit. The feature quantity data generation unit acquires time-series data of sensor data regarding the movement of the foot. The feature quantity data generation unit extracts gait waveform data for one gait cycle from the time-series data of the sensor data. The feature quantity data generation unit normalizes the extracted gait waveform data. The feature quantity data generation unit extracts, from the normalized gait waveform data, a feature quantity regarding the body condition of the estimation target from a gait phase cluster including at least one temporally continuous gait phase. The feature quantity data generation unit extracts feature quantities selected by the feature quantity selection devices of the first to fourth example embodiments. The feature quantity data generation unit generates feature quantity data including the extracted feature quantity. The feature quantity data generation unit outputs the generated feature quantity data.

The body condition estimation device includes a data acquisition unit, a storage unit, an estimation unit, and an output unit. The data acquisition unit acquires feature quantity data including a feature quantity extracted from the feature of the gait of the user and used for estimating the body condition of the user. The storage unit stores an estimation model that outputs a body condition in response to input of the feature quantity data. The estimation unit inputs the acquired feature quantity data to the estimation model to estimate the body condition of the user. The output unit outputs information on the estimated body condition.

The body condition estimation system of the present example embodiment estimates the body condition of the user using the feature quantity extracted from the feature of the gait of the user. Thus, with the body condition estimation system of the present example embodiment, the body condition can be appropriately estimated in daily life using the feature quantity with high robustness.

### (Hardware)

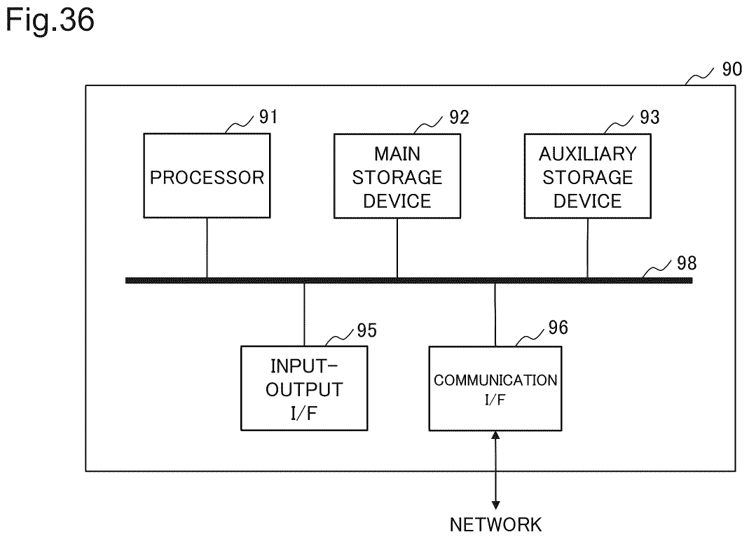

Here, a hardware configuration for executing processing according to each example embodiment of the present disclosure will be described using the information processing device 90 of FIG. 36 as an example. The information processing device 90 in FIG. 36 is a configuration example for executing processing of each example embodiment, and does not limit the scope of the present disclosure.

As illustrated in FIG. 36, the information processing device 90 includes a processor 91, a main storage device 92, an auxiliary storage device 93, an input-output interface 95, and a communication interface 96. In FIG. 36, the interface is abbreviated as an interface (I/F). The processor 91, the main storage device 92, the auxiliary storage device 93, the input-output interface 95, and the communication interface 96 are data-communicably connected to each other via a bus 98. The processor 91, the main storage device 92, the auxiliary storage device 93, and the input-output interface 95 are connected to a network such as the Internet or an intranet via the communication interface 96.

The processor 91 develops the program stored in the auxiliary storage device 93 or the like in the main storage device 92. The processor 91 executes the program developed in the main storage device 92. In the present example embodiment, it is only required to use a software program installed in the information processing device 90. The processor 91 executes processing according to each example embodiment.

The main storage device 92 has an area in which a program is developed. A program stored in the auxiliary storage device 93 or the like is developed in the main storage device 92 by the processor 91. The main storage device 92 is implemented by, for example, a volatile memory such as a dynamic random access memory (DRAM). A nonvolatile memory such as a magnetoresistive random access memory (MRAM) may be configured and added as the main storage device 92.

The auxiliary storage device 93 stores various data such as programs. The auxiliary storage device 93 is implemented by a local disk such as a hard disk or a flash memory. In addition, the main storage device 92 may be configured to store various data, and the auxiliary storage device 93 may be omitted.

The input-output interface 95 is an interface for connecting the information processing device 90 and a peripheral device based on a standard or a specification. The communication interface 96 is an interface for connecting to an external system or device through a network such as the Internet or an intranet based on a standard or a specification. The input-output interface 95 and the communication interface 96 may be shared as an interface connected to an external device.

Input devices such as a keyboard, a mouse, and a touch panel may be connected to the information processing device 90 as necessary. These input devices are used to input information and settings. In a case where the touch panel is used as the input device, the display screen of the display device may also serve as the interface of the input device. Data communication between the processor 91 and the input device is only required to be mediated by the input-output interface 95.

The information processing device 90 may be provided with a display device for displaying information. In a case where a display device is provided, the information processing device 90 preferably includes a display control device (not illustrated) for controlling display of the display device. The display device is only required to be connected to the information processing device 90 via the input-output interface 95.

The information processing device 90 may be provided with a drive device. The drive device mediates reading of data and a program from a recording medium, writing of a processing result of the information processing device 90 to the recording medium, and the like between the processor 91 and the recording medium (program recording medium). The drive device only needs to be connected to the information processing device 90 via the input-output interface 95.

The above is an example of a hardware configuration for enabling processing according to each example embodiment of the present invention. The hardware configuration of FIG. 36 is an example of a hardware configuration for executing processing according to each example embodiment, and does not limit the scope of the present invention. A program for causing a computer to execute processing according to each example embodiment is also included in the scope of the present invention. Further, a program storage medium in which the program according to each example embodiment is stored is also included in the scope of the present invention. The storage medium can be achieved by, for example, an optical storage medium such as a compact disc (CD) or a digital versatile disc (DVD). The recording medium may be implemented by a semiconductor recording medium such as a universal serial bus (USB) memory or a secure digital (SD) card. The recording medium may be implemented by a magnetic recording medium such as a flexible disk, or another recording medium. When a program executed by the processor is recorded in a recording medium, the recording medium corresponds to a program recording medium.

The components of each example embodiment may be combined in any manner. The components of each example embodiment may be implemented by software or may be implemented by a circuit.

While the present invention has been particularly shown and described with reference to example embodiments thereof, the invention is not limited to example embodiments above. It will be understood by those of ordinary skill in the art that various changes in form and details may be made therein without departing from the spirit and scope of the present invention as defined by the claims.

### REFERENCE SIGNS LIST

5 machine learning system
6 body condition estimation system
10, 20, 30, 40 feature quantity selection device
11, 21, 31, 41 acquisition unit
12, 22, 32, 42 construction unit
13, 23, 33, 43 analysis unit
15, 25, 35, 45 statistics unit
17, 27, 37, 47 selection unit
19, 29, 39, 49 output unit
26 estimation model construction unit
50, 60 gait measuring device
55 machine learning device
61 sensor
62 feature quantity data generation unit
63 estimation device
551 reception unit
553 machine learning unit
555 storage unit
631 data acquisition unit
632 storage unit
633 estimation unit
635 output unit

What is claimed is:

1. A feature quantity selection device comprising:
a memory storing instructions; and
a processor connected to the memory and configured to execute the instructions to:
acquire a plurality of data sets;
construct a plurality of re-extracted data sets by changing a distribution of data included in the data set;
analyze the plurality of re-extracted data sets using a Lasso regression method;
aggregate values of elements included in the plurality of re-extracted data sets in accordance with an analysis result of the plurality of re-extracted data sets and set a logical value to the elements included in the plurality of re-extracted data sets in accordance with an aggregation result of the values of the elements;
select a combination of feature quantities in accordance with a value of the logical value set to the elements in accordance with a preset specifying rule; and
output selection information regarding the selected combination of the feature quantities.

2. The feature quantity selection device according to claim 1, wherein
the processor is configured to execute the instructions to
construct the plurality of re-extracted data sets using a Leave-One-Subject-Out method.

3. The feature quantity selection device according to claim 1, wherein
the processor is configured to execute the instructions to
construct the plurality of re-extracted data sets using a bootstrap method.

4. The feature quantity selection device according to claim 1, wherein
the processor is configured to execute the instructions to
perform the Lasso regression for each of a plurality of preset regularization parameters for the plurality of re-extracted data sets, and
generate a first matrix of a plurality of patterns including a column related to the regularization parameter used in the Lasso regression and a row related to the feature quantity,
execute first statistical processing of setting a first logical value of a cell of a non-zero element to 1 and a first logical value of a cell of a zero element to 0 for the first matrix of the plurality of patterns,
execute second statistical processing of aggregating the first logical values for each of cells constituting the first matrix of the plurality of patterns, and generating a second matrix in which 1 is set as a second logical value to a cell in which an aggregated value of the first logical values satisfies a predetermined condition, and 0 is set as the second logical value to a cell in which the aggregated value of the first logical values does not satisfy the predetermined condition, and
select a column of the second matrix in accordance with the preset specifying rule, and selects a combination of the feature quantities related to the selected column.

5. The feature quantity selection device according to claim 4, wherein
in the second statistical processing,
the processor is configured to execute the instructions to
calculate a total value of the first logical values for each of cells constituting the first matrix of the plurality of patterns, and
generate the second matrix in which the second logical value of a cell in which the total value of the first logical values is equal to or more than a predetermined threshold is set to 1, and a cell in which the total value of the first logical values is less than the predetermined threshold is set to 0.

6. The feature quantity selection device according to claim 4, wherein
in the second statistical processing,
the processor is configured to execute the instructions to calculate an average value of the first logical values for each of cells constituting the first matrix of the plurality of patterns, and
generate the second matrix in which the second logical value of a cell in which the average value of the first logical values is equal to or more than a predetermined threshold is set to 1, and a cell in which the average value of the first logical values is less than the predetermined threshold is set to 0.

7. The feature quantity selection device according to claim 1, wherein
the processor is configured to execute the instructions to
perform the Lasso regression for each of a plurality of preset regularization parameters for each of the plurality of re-extracted data sets,
generate a first matrix of a plurality of patterns including a column related to the regularization parameter used in the Lasso regression and a row related to the feature quantity,
execute second statistical processing of aggregating values of the elements for each of cells constituting the first matrix of the plurality of patterns, and generating a second matrix in which 1 is set as a second logical value to a cell in which an average value of the values of the elements is equal to or more than a predetermined threshold, and 0 is set as the second logical value to a cell in which the average value of the values of the elements is less than the predetermined threshold; and
select a column of the second matrix in accordance with the preset specifying rule, and selects a combination of the feature quantities related to the selected column.

8. The feature quantity selection device according to claim 1, wherein
the processor is configured to execute the instructions to
construct an estimation model by machine learning using the selected feature quantity,
evaluate the constructed estimation model,
select a combination of the feature quantities in accordance with an evaluation result of the estimation model, and
output recommendation information that supports a user for making decision about taking an action for practicing training leading to improvement of a total body muscle strength based on the evaluation result.

9. A feature quantity selection method for a computer to perform:
acquiring a plurality of data sets;
constructing a plurality of re-extracted data sets by changing a distribution of data included in the data set;
analyzing the plurality of re-extracted data sets using a Lasso regression method;
aggregating values of elements included in the plurality of re-extracted data sets in accordance with an analysis result of the plurality of re-extracted data sets;
setting a logical value to the elements included in the plurality of re-extracted data sets in accordance with an aggregation result of the values of the elements;
selecting a combination of feature quantities in accordance with a value of the logical value set to the elements in accordance with a preset specifying rule; and
outputting selection information regarding the selected combination of the feature quantities.

10. A non-transitory recording medium on which a program is recorded for causing a computer to execute:
a process of acquiring a plurality of data sets;
a process of constructing a plurality of re-extracted data sets by changing a distribution of data included in the data set;
a process of analyzing the plurality of re-extracted data sets using a Lasso regression method;
a process of aggregating values of elements included in the plurality of re-extracted data sets in accordance with an analysis result of the plurality of re-extracted data sets;
a process of setting a logical value to the elements included in the plurality of re-extracted data sets in accordance with an aggregation result of the values of the elements;
a process of selecting a combination of feature quantities in accordance with a value of the logical value set to the elements in accordance with a preset specifying rule; and
a process of outputting selection information regarding the selected combination of the feature quantities.
